(19) United States
(12) Patent Application Publication
(10) Pub. No.: US 2011/0234185 A1
(43) Pub. Date: Sep. 29, 2011

(54) SEMICONDUCTOR-DEVICE DRIVING CIRCUIT, AND SEMICONDUCTOR APPARATUS INCLUDING DRIVING CIRCUIT

(76) Inventors: Hisanori NAGASE, Osaka (JP); Naoyuki Nakamura, Kyoto (JP); Shuji Tamaoka, Kyoto (JP)

(21) Appl. No.: 13/069,840

(22) Filed: Mar. 23, 2011

(30) Foreign Application Priority Data
Mar. 25, 2010 (JP) 2010-070550

(51) Int. Cl. G05F 1/571; G05F 1/573

(52) U.S. Cl. 323/277

(57) ABSTRACT

It is an object of the present invention to provide a driving circuit which is adapted, for a semiconductor device which exhibits a diode characteristic of flowing an abrupt current if the gate-source voltage therein exceeds a predetermined voltage, to have the functions of reducing electric-power consumption in high-load state, reducing the loss in the driving circuit in low-load states, preventing excessive voltages, excessive currents and excessive electric-power consumption, and reducing the loss in the semiconductor device. A gate control part in a driving circuit is adapted to control the voltage or the current which is supplied to the gate of a semiconductor device, according to signals indicative of operation states of the semiconductor device, wherein these signals are inputted from an operation-state detection part which detects operation states of the semiconductor device, and the semiconductor device exhibits a diode characteristic of flowing an abrupt current if the gate-source voltage therein exceeds a predetermined voltage.

### FIELD OF THE INVENTION

The present invention relates to a driving circuit having a function of protecting a semiconductor device, such as a field-effect transistor (FET) which employs an electrode having a p-type region or a Schottky junction as a gate, against excessive voltages, excessive currents and excessive electric power in conduction states. The present invention also relates to a semiconductor apparatus including such a driving circuit.

### BACKGROUND OF THE INVENTION

In recent years, attention has focused on FETs which employ GaN-based compound semiconductor devices, as power semiconductor devices. Such GaN-based FETs have excellent material characteristics in comparison with conventional Si-based semiconductor devices and can raise the possibility of realizing electric power consumption reduced to fractions of those of Si-based MOSFETs, for example. However, GaN-based FETs employing p-type regions as their gates still have the problem of increases of device losses along with increases of their drain-source voltages (Vds). Further, FETs employing electrodes having Schottky junctions also have the problem of increases of the device losses due to excessive currents flowing through the device along with increases of their drain-source voltages (Vds).

Japanese Unexamined Patent Publication No. H11-261053 discloses an example of techniques of GaN-based FETs as described above, and Japanese Unexamined Patent Publication No. 2003-78362 discloses techniques for detection of increased losses in devices. Further, Japanese Unexamined Patent Publication No. 2006-135241 discloses an example of an FET which employs an electrode having a Schottky junction. Hereinafter, there will be described an GaN-based FET disclosed in Japanese Unexamined Patent Publication No. H11-261053, and an excessive-current suppression circuit for a Si-based semiconductor device which is disclosed in Japanese Unexamined Patent Publication No, 2003-78362.

FIG. 15 is a cross-sectional view illustrating an exemplary structure of a GaN-based FET which employs a p-type region as its gate. Referring to FIG. 15, on a semi-insulating substrate 101 made of a Si single crystal, there are formed, through epitaxial growth, a GaN buffer layer 102, an i-type GaN layer 103, an n-type AlGaN layer 104, and a p-type GaN layer 105, in this order from the bottom. Further, electrodes as a source 106 and a drain 108 are formed on the n-type AlGaN layer 104, and an electrode as a gate 107 is formed on the p-type GaN layer 105. In the GaN-based FET formed as described above, there is a pn-junction structure under the gate 107 and, if a voltage is applied to the gate 107, a two-dimensional electron gas layer 103a is formed at a heterojunction interface between the n-type AlGaN layer 104 and the i-type GaN layer 103, which enables realization of operations for moving electrons at high speeds and control of the drain-source current.

FIG. 16 is a circuit diagram illustrating an example of a conventional electric-power semiconductor apparatus including an excessive-current suppression circuit for a Si-based semiconductor device. In the electric-power semiconductor apparatus in FIG. 16, an output transistor 202, which is a Si-based semiconductor device, is connected at its emitter-collector portion, between a driving voltage terminal IN for applying a driving voltage Vin thereto and an output terminal OUT for extracting an output voltage Vo therefrom. Further, the conventional electric-power semiconductor apparatus illustrated in FIG. 16 includes, in addition to the output transistor 202, a driving circuit 201 for driving and controlling the base of the output transistor 202, a detection resistance device 217 for detecting an output current Ioc from the output transistor 202, a collector-emitter voltage detection circuit 240 for the output transistor 202, and an excessive-current suppression circuit 230 for controlling an excessive-current limit value for the output current Ioc according to the value detected by the collector-emitter voltage detection circuit 240.

FIG. 17 is a characteristic diagram indicating a safe operation area for the output transistor 202 in the conventional semiconductor apparatus illustrated in FIG. 16. Due to effects of conjunctive operations of the collector-emitter voltage detection circuit 240 and the excessive-current suppression circuit 230, a collector-emitter voltage (Vce) and the output current Ioc from the output transistor 202 are operated within the range of a safe operation area (SOA) in FIG. 17. Accordingly, the collector-emitter voltage (Vce) and the output current Ioc from the output transistor 202 are both limited to values equal to or less than predetermined values, which protects the output transistor 202 against excessive voltages and excessive currents. Further, the gradient of an inclined portion S of the safe operation area SOA is determined by the setting of circuit constants and corresponds to an approximation of a curve of the limit of the electric power consumption of the output transistor 202. Accordingly, the conventional electric-power semiconductor apparatus illustrated in FIG. 16 also operates as an excessive electric-power consumption protector. If the output current Ioc is deviated from the area SOA of FIG. 17 due to a short-circuit of an external load and the like, the driving circuit 201 controls the output transistor 202 for bringing it into an OFF state to stop the operation of the output transistor 202.

In FIG. 15, the n-type AlGaN layer 104 and the p-type GaN layer 105 forms a pn junction, and the n-type AlGaN layer 104 contacts at its one end with the electrode of the source 106. Usually, the source 106 is grounded, and the voltage applied to the gate 107 is lower than the voltage applied to the drain 108 in usage states, which induces a state where a diode is formed between the gate 107 and the source 106.

Further, even when the n-type AlGaN layer 104 is made of an non-doped AlGaN layer, the two-dimensional electron gas layer 103a and the p-type GaN layer 105 are brought into a state where a diode is formed therein, thereby inducing a state where a diode is formed between the gate 107 and the source 106.

FIG. 18A is a graph illustrating an exemplary characteristic curve about gate-source voltage (Vgs) and gate-source current (Igs) in the GaN-based FET employing a p-type region as its gate illustrated in FIG. 15. As illustrated in FIG. 18A, this exhibits a characteristic similar to a voltage-current characteristic of a common diode which has a varying equivalent resistance depending on the magnitudes of the applied voltage and the current flowing therein and, if the gate-source voltage (Vgs) exceeds a certain voltage, the gate-source current (Igs) abruptly increases. However, there is uniquely a one-to-one correspondence between the gate-source voltage (Vgs) and the gate-source current (Igs).

FIG. 18B is a graph illustrating exemplary characteristic curves about drain-source voltage (Vds) and drain-source current (Ids) in a GaN-based FET employing a p-type region as its gate, as a semiconductor device.

Referring to FIG. 18B, when the gate-source voltage (Vgs) is fixed to 3 V (namely, the gate-source current (Igs) is also fixed), a load current indicated by a current value of Ia, for example, is flowed as the drain-source current (Ids) and, at this time, the drain-source voltage (Vds) is an output voltage indicated by a voltage value of Va. In this case, if the load current which is the drain-source current (Ids) changes its value from the current value Ia to a current value (Ib), due to a change of an external load and the like, the drain-source voltage (Vds) changes its value from the voltage value Va to a voltage value Vb and, thus, largely increases. Consequently, the electric power consumption in the semiconductor device is changed from (Va-Ia) to (Vb-Ib). These magnitudes of the electric power consumption are expressed by the areas indicated by respective inclined lines in FIG. 18B, which enables understanding that the electric power consumption is significantly increased due to the load change.

On the other hand, when the gate-source voltage (Vgs) is fixed to 4 V, for example, if the drain-source current (Ids) flowing therein as the load current has a current value of Ib, the drain-source voltage (Vds) has a voltage value of Vc.

Referring to the characteristic curves illustrated in FIG. 18B, by comparing the electric power consumption with the gate-source voltage (Vgs) of 3 V with the electric power consumption with the gate-source voltage of 4 V, it can be seen that (Vb-Ib) is larger than (Vc-Ib) and, for the same value of the drain-source current (Ids), the electric power consumption decreases with increasing gate-source voltage (Vgs). However, in the GaN-based FET, as illustrated in FIG. 18A, if the gate-source voltage (Vgs) is increased from 3 V to 4 V, the gate-source current figs) abruptly increases. Such an abrupt increase of the gate-source current (Igs) will become a large burden on the driving circuit which supplies a current to the gate, which increases the loss in the semiconductor device itself and the driving circuit. This has induced the significant problem of degradation of rising characteristics during high-speed switching.

Further, the FET which employs an electrode having a Schottky junction disclosed in Japanese Unexamined Patent Publication No. 2006-135241 also exhibits a diode characteristic of flowing abrupt current if the gate-source voltage exceeds a predetermined voltage, similarly to the aforementioned GaN-based FET employing a p-type region as its gate. This has exerted a large burden on the driving circuit which supplies a current to the gate, which has increased the losses in the semiconductor device itself and the driving circuit, thereby inducing the same problem of degradation of rising characteristics during high-speed switching.

The conventional electric-power semiconductor apparatus including the excessive-current suppression circuit illustrated in FIG. 16 is structured to detect an excessive voltage, an excessive current and excessive electric-power consumption in the output transistor and to perform an operation for immediately shutting down (OFF operation) the output transistor on detecting such a state of an excessive voltage, an excessive current and excessive electric power consumption, as described above. Accordingly, with the structure of the conventional electric-power semiconductor apparatus illustrated in FIG. 16, depending on the abnormal state, the voltage and current immediately become zero, after the operation for shutting down the output transistor. Accordingly, after re-starting an operation for driving the output transistor, an excessive voltage, an excessive current or excessive electric power consumption may be detected, again, and, then, a shut-down operation may be performed. This has raised the possibility of repeat of shut-down operations and driving operations.

### SUMMARY OF THE INVENTION

The present invention has been made in view of the above circumstances of conventional apparatuses and aims at providing a driving circuit for a semiconductor device, such as FET employing a p-type region or a Schottky electrode as its gate, which is adapted to detect an increase of electric-power consumption in the semiconductor device from a voltage between input and output terminals in the semiconductor device and from an output current thereof or to detect electric power consumption from a voltage between input and output terminals and from an output current and, further, to accumulatively increase or decrease the gate current according to the increase or decrease of the electric power consumption, thereby being provided with a protection function of preventing excessive voltages, excessive currents, and excessive electric power consumption in conduction states and a function of reducing the loss of the semiconductor device, as well as being capable of reducing the electric power consumption in the semiconductor device in high-load states and reducing the loss in the driving circuit in low-load states. Also, the present invention aims at providing a semiconductor apparatus having such a driving circuit.

To achieve the above object, a semiconductor-device driving circuit according to a first aspect of the present invention includes:

an operation-state detection part adapted to detect an operation state of a semiconductor device which exhibits a diode characteristic of flowing an abrupt current when its gate-source voltage exceeds a predetermined voltage; and

a gate control part adapted to receive a signal indicative of the operation state of the semiconductor device from the operation-state detection part and to control a voltage or current supplied to the gate of the semiconductor device according to the signal indicative of the operation state of the semiconductor device. With the semiconductor-device driving circuit having the aforementioned structure according to the first aspect of the present invention, it is possible to reduce electric power consumption of the semiconductor device in high-load states and to reduce the loss in the driving circuit in low-load states.

In a semiconductor-device driving circuit according to a second aspect of the present invention, the semiconductor device according to the first aspect has a p-type region or a Schottky electrode as its gate,

the operation-state detection part includes a voltage detection part adapted to determine the voltage between input and output terminals in the semiconductor device, and

on receiving a determined value of the voltage between the input and output terminals in the semiconductor device from the voltage detection part, the gate control part may control the current supplied to the gate of the semiconductor device, when the determined voltage value of the voltage between the input and output terminals in the semiconductor device exceeds at least a changeover reference voltage set value. With the semiconductor-device driving circuit having the aforementioned structure according to the second aspect of the present invention, it is possible to determine an operation state of the semiconductor device, such as an electric-power consumption state, from an increase or decrease of electric power consumption, based on a voltage between input and output terminals in the semiconductor device, and to accumulatively increase or decrease the gate current according to the increase or decrease of the electric power consumption. This enables integrating the function of protecting the semiconductor device against excessive voltages and excessive electric power consumption in conduction states and the function of reducing the loss in the semiconductor device, as well as reducing the electric power consumption in the semiconductor device in high load states and reducing the loss in the driving circuit in low load states. This can realize excellent safety and reliability and energy saving.

In a semiconductor-device driving circuit according to a third aspect of the present invention, the gate control part according to the second aspect of the present invention may be adapted to receive a determined voltage value of the voltage between the input and output terminals in the semiconductor device, from the voltage detection part, at every predetermined periodic interval,

when the determined voltage value is equal to or larger than a first changeover reference voltage set value, the gate control part makes the gate current supplied to the gate of the semiconductor device equal to the gate current before the determination plus a predetermined amount, such that a first gate current set value is an upper limit, and

when the determined voltage value is equal to or smaller than a second changeover reference voltage set value, the gate control part makes the gate current supplied to the gate of the semiconductor device equal to the gate current before the determination minus a predetermined amount, such that a second gate current set value is a lower limit.

In a semiconductor-device driving circuit according to a fourth aspect of the present invention, the gate control part according to the second or third aspect may be adapted to receive a determined voltage value of the voltage between the input and output terminals in the semiconductor device from the voltage detection part and,

adapted to stop the driving of the semiconductor device, after the determined voltage value gets to be equal to or larger than an upper-limit reference voltage set value.

In a semiconductor-device driving circuit according to a fifth aspect of the present invention, the semiconductor device according to the first aspect has a p-type region or a Schottky electrode as its gate,

the operation-state detection part includes a current detection part adapted to determine the output current of the semiconductor device, and

on receiving a determined current value of the output current of the semiconductor device, the gate control part may control the current supplied to the gate of the semiconductor device, when the determined current value of the output current of the semiconductor device exceeds at least a changeover reference current set value. With the semiconductor-device driving circuit having the aforementioned structure according to the fifth aspect of the present invention, it is possible to determine an operation state of the semiconductor device, such as an electric-power consumption state, from an increase or decrease of electric power consumption, based on an output current from the semiconductor device, and to accumulatively increase or decrease the gate current according to the increase or decrease of the electric power consumption. This enables integrating the function of protecting the semiconductor device against excessive currents and excessive electric power consumption in conduction states and the function of reducing the loss in the semiconductor device, as well as reducing the electric power consumption in the semiconductor device in high load states and reducing the loss in the driving circuit in low load states. This can realize excellent safety and reliability and energy saving.

In a semiconductor-device driving circuit according to a sixth aspect of the present invention, the gate control part according to the fifth aspect may be adapted to receive a determined current value of the output current of the semiconductor device, from the current detection part, at every predetermined periodic interval,

when the determined current value is equal to or larger than a first changeover reference current set value, the gate control part makes the gate current supplied to the gate of the semiconductor device equal to the gate current before the determination plus a predetermined amount, such that a first gate current set value is an upper limit, and

when the determined current value is equal to or smaller than a second changeover reference current set value, the gate control part makes the gate current supplied to the gate of the semiconductor device equal to the gate current before the determination minus a predetermined amount, such that a second gate current set value is a lower limit.

In a semiconductor-device driving circuit according to a seventh aspect of the present invention, the gate control part according to the fifth or sixth aspect may be adapted to receive a determined current value of the output current of the semiconductor device from the current detection part and,

adapted to stop the driving of the semiconductor device, after the determined current value gets to be equal to or larger than an upper-limit reference current set value.

In a semiconductor-device driving circuit according to an eighth aspect of the present invention, the semiconductor device according to the first aspect has a p-type region or a Schottky electrode as its gate,

the operation-state detection part includes

a voltage detection part adapted to determine the voltage between input and output terminals in the semiconductor device,

a current detection part adapted to determine the output current of the semiconductor device, and

an electric-power detection part adapted to determine electric power consumption in the semiconductor device, from a determined voltage value of the voltage between the input and output terminals from the voltage detection part, and from a determined current value of the output current from the current detection part, and

the gate control part, on receiving a determined value of the electric power consumption in the semiconductor device, may control the current supplied to the gate of the semiconductor device, when the determined value of the electric power consumption in the semiconductor device exceeds at least a changeover reference electric-power set value. With the semiconductor-device driving circuit having the aforementioned structure according to the eighth aspect of the present invention, it is possible to determine an operation state of the semiconductor device, such as an electric-power consumption state, from electric power consumption based on a voltage between input and output terminals in the semiconductor device and an output current therefrom, and to accumulatively increase or decrease the gate current according to the increase or decrease of the electric power consumption. This enables integrating the function of protecting the semiconductor device against excessive electric power consumption in conduction states and the function of reducing the loss in the semiconductor device, as well as reducing the electric power consumption in the semiconductor device in high load states and reducing the loss in the driving circuit in low load states. This can realize excellent safety and reliability and energy saving.

In a semiconductor-device driving circuit according to a ninth aspect of the present invention, the gate control part according to the eighth aspect may be adapted to receive a determined value of the electric power consumption in the semiconductor device from the electric-power detection part, at every predetermined periodic interval,

when the determined value of the electric-power consumption is equal to or larger than a first changeover reference electric-power set value, the gate control part makes the gate current supplied to the gate of the semiconductor device equal to the gate current before the determination plus a predetermined amount, such that a first gate current set value is an upper limit, and

when the determined value of the electric power consumption is equal to or smaller than a second changeover reference electric-power set value, the gate control part makes the gate current supplied to the gate of the semiconductor device equal to the gate current before the determination minus a predetermined amount, such that a second gate current set value is a lower limit.

In a semiconductor-device driving circuit according to a tenth aspect of the present invention, the gate control part according to the eighth or ninth aspect may be adapted to receive a determined value of the electric power consumption in the semiconductor device from the electric-power detection part and,

adapted to stop the driving of the semiconductor device, after the determined value of the electric power consumption gets to be equal to or larger than an upper-limit reference electric-power set value.

In the semiconductor-device driving circuit according to an eleventh aspect of the present invention, the semiconductor device according to the first aspect has a p-type region or a Schottky electrode as its gate,

the operation-state detection part includes

a voltage detection part adapted to determine the voltage between input and output terminals in the semiconductor device,

a current detection part adapted to determine the output current of the semiconductor device, and

an electric-power detection part adapted to determine electric power consumption in the semiconductor device, from a determined voltage value of the voltage between the input and output terminals from the voltage detection part, and from a determined current value of the output current from the current detection part, and

the gate control part may be adapted to control the current supplied to the gate of the semiconductor device, when a determined voltage value from the voltage detection part exceeds at least a changeover reference voltage set value, when a determined current value from the current detection part exceeds at least a changeover reference current set value, or when a determined value of the electric power consumption from the electric-power detection part exceeds at least a changeover reference electric-power set value. With the semiconductor-device driving circuit having the aforementioned structure according to an eleventh aspect of the present invention, it is possible to determine an operation state of the semiconductor device, such as an electric-power consumption state, from electric power consumption based on a voltage between input and output terminals in the semiconductor device, an output current therefrom or both a voltage between input and output terminals in the semiconductor device and an output current therefrom, and to accumulatively increase or decrease the gate current according to the increase or decrease of the electric power consumption. This enables integrating the function of protecting the semiconductor device against excessive voltages, excessive currents and excessive electric power consumption in conduction states and the function of reducing the loss in the semiconductor device, as well as reducing the electric power consumption in the semiconductor device in high load states and reducing the loss in the driving circuit in low load states. This can realize excellent safety and reliability and energy saving.

In a semiconductor-device driving circuit according to a twelfth aspect of the present invention, the gate control part according to the eleventh aspect may be adapted to receive a determined voltage value of the voltage between the input and output terminals in the semiconductor device from the voltage detection part, a determined current value of the output current of the semiconductor device from the current detection part, and a determined value of the electric power consumption in the semiconductor device from the electric-power detection part, and

the gate control part may include a selector for selectively performing, according to the magnitude of the gate current, an operation out of a first operation for, when the determined voltage value is equal to or larger than a changeover reference voltage set value, making the gate current supplied to the gate of the semiconductor device equal to the gate current before the determination plus a predetermined amount such that a first: gate current set value is an upper limit, a second operation for, when the determined current value is equal to or larger than a changeover reference current set value, making the gate current supplied to the gate of the semiconductor device equal to the gate current before the determination plus a predetermined amount such that a second gate current set value is an upper limit, and a third operation for, when the determined electric-power-consumption value is equal to or larger than a first changeover reference electric-power set value, making the gate current supplied to the gate of the semiconductor device equal to the gate current before the determination plus a predetermined amount such that a third gate current set value is an upper limit, and

when the determined electric-power-consumption value is equal to or smaller than a second changeover reference electric-power set value, regardless of the operation selected by the selector, the gate control part makes the gate current supplied to the gate of the semiconductor device equal to the gate current before the determination minus a predetermined amount, such that a fourth gate current set value is a lower limit.

In a semiconductor-device driving circuit according to a thirteenth aspect of the present invention, the gate control part according to the eleventh or twelfth aspect may be adapted to stop the driving of the semiconductor device, after the determined voltage value gets to be equal to or larger than an upper-limit reference voltage set value, after the determined current value gets to be equal to or larger than an upper-limit reference current set value, and after the determined electric-power-consumption value gets to be equal to or larger than an upper-limit reference electric-power set value.

In a semiconductor-device driving circuit according to a fourteenth aspect of the present invention, the semiconductor device according to the first to thirteenth aspects may be an FET which employs a p-type region or a Schottky electrode as its gate.

A semiconductor apparatus according to a fifteenth aspect of the present invention includes the semiconductor-device driving circuit according to any one of the first to fourteenth aspects, and a semiconductor device adapted to be driven and controlled by the driving circuit. With the semiconductor apparatus having the aforementioned structure according to the fifteenth aspect of the present invention, it is possible to reduce electric power consumption in the semiconductor device in high-load states and to reduce of the loss in the driving circuit in low-load states and, also, it is possible to prevent excessive voltages, excessive currents and excessive electric power consumption in the semiconductor device in conduction states. Therefore, the apparatus has excellent characteristics of having excellent safety and reliability and facilitating energy saving. Further, the semiconductor apparatus having the aforementioned structure according to the present invention can be structured with simple circuit structures. Accordingly, it is possible to fabricate such an apparatus having excellent characteristics, with reduced costs.

According to the present invention, it is possible to provide a driving circuit and a semiconductor apparatus which are adapted to determine an operation state of the semiconductor device, such as electric power consumption state, from electric-power consumption, based on a voltage between input and output terminals in the semiconductor device, an output current from the semiconductor device or both a voltage between input and output terminals of the semiconductor device and an output current thereof, and, further, are adapted to accumulatively increase or decrease the gate current according to the increase or decrease of the electric power consumption, which can integrate the function of protecting the semiconductor device against excessive voltages, excessive currents and excessive electric power consumption in conduction states and the function of reducing the loss in the semiconductor device, as well as reducing the electric power consumption in the semiconductor device in high-load states and reducing the loss in the driving circuit in low-load states, thereby realizing excellent safety and reliability and attaining energy saving.

### BRIEF DESCRIPTION OF THE DRAWINGS

The present invention will become more fully understood from the detailed description and the accompanying drawings, wherein:

FIG. 1 is a block diagram illustrating the circuit structures of a driving circuit and a semiconductor apparatus having the driving circuit, according to a first embodiment of the present invention;

FIG. 2 is a block diagram illustrating the circuit structure of a gate control part in the driving circuit according to the first embodiment of the present invention;

FIG. 3 is a waveform diagram illustrating main signals at respective portions according to the first embodiment of the present invention;

FIG. 4 is a characteristic diagram illustrating the relationship between the drain-source voltage (Vds) and the drain-source current (Ids) in the FET switching device employing a p-type region as its gate, according to the first embodiment of the present invention;

FIG. 5 is a block diagram illustrating the circuit structures of a driving circuit and a semiconductor apparatus having the driving circuit, according to a second embodiment of the present invention;

FIG. 6 is a block diagram illustrating the circuit structure of a gate control part according to the second embodiment of the present invention;

FIG. 7 is a waveform diagram illustrating main signals at respective portions according to the second embodiment of the present invention;

FIG. 8 is a characteristic diagram illustrating the relationship between the drain-source voltage (Vds) and the drain-source current (Ids) in the FET switching device employing a p-type region as its gate, according to the second embodiment of the present invention;

FIG. 9 is a block diagram illustrating the circuit structures of a driving circuit and a semiconductor apparatus having the driving circuit, according to a third embodiment of the present invention;

FIG. 10 is a characteristic diagram illustrating the relationship between the drain-source voltage (Vds) and the drain-source current (Ids) in the FET switching device employing a p-type region as its gate, according to the third embodiment of the present invention;

FIG. 11 is a block diagram illustrating the circuit structures of a driving circuit and a semiconductor apparatus having the driving circuit, according to a fourth embodiment of the present invention;

FIG. 12 is a block diagram illustrating the circuit structure of a gate control part in the driving circuit according to the fourth embodiment of the present invention;

FIG. 13 is a block diagram illustrating the circuit structure of a gate current setting part in the driving circuit according to the fourth embodiment of the present invention;

FIG. 14 is a characteristic diagram illustrating the relationship between the drain-source voltage (Vds) and the drain-source current (Ids) in the FET switching device employing a p-type region as its gate, according to the fourth embodiment of the present invention;

FIG. 15 is a cross-sectional view illustrating an exemplary structure of a GaN-based FET which employs a p-type region as its gate;

FIG. 16 is a circuit diagram illustrating an example of a conventional electric-power semiconductor apparatus including an excessive-current suppression circuit;

FIG. 17 is a characteristic diagram indicating a safe operation area for the output transistor in the electric-power semiconductor apparatus illustrated in FIG. 16;

FIG. 18A is a graph illustrating an exemplary characteristic curve about gate-source voltage (Vgs) and gate-source current (Igs) in the GaN-based FET employing a p-type region as its gate illustrated in FIG. 15; and

FIG. 18B is a graph illustrating exemplary characteristic curves about drain-source voltage (Vds) and drain-source current (Ids).

### DETAILED DESCRIPTION OF THE PREFERRED EMBODIMENTS

Hereinafter, a detailed description will be given of preferred embodiments of a driving circuit and a semiconductor apparatus employing the driving circuit according to the present invention with reference to the accompanying drawings. Further, the present invention is not intended to be restricted by the concrete structures described in the following embodiments and is intended to further include structures based on technical concepts similar to the technical concepts described in the embodiments and based on technical common senses in this technical field.

### First Embodiment

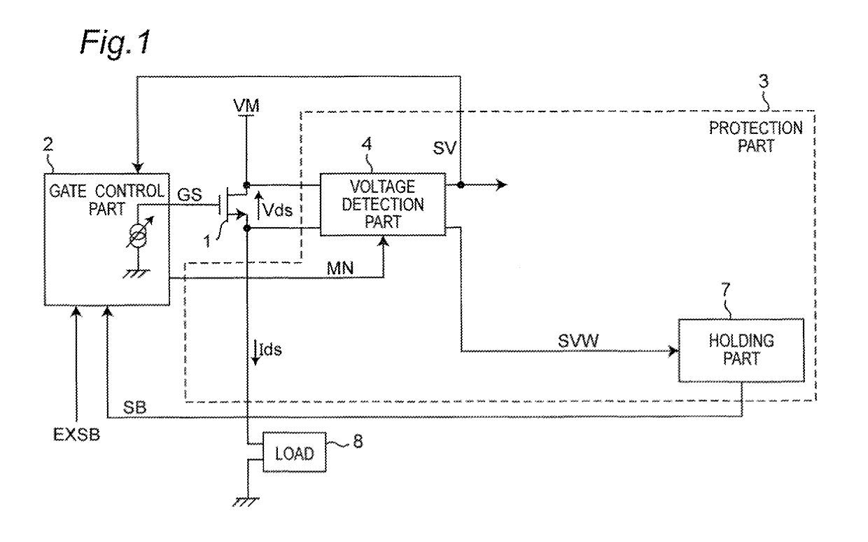

FIG. 1 is a block diagram illustrating the circuit structures of a driving circuit and a semiconductor apparatus having the driving circuit, according to a first embodiment of the present invention. In FIG. 1, a switching device 1 as a semiconductor device which is driven and controlled by the driving circuit according to the first embodiment is an FET which employs a p-type region as its gate. In this case, “an FET which employs a p-type region as its gate” refers to an FET which has a semiconductor laminated-layer structure and includes a p-type semiconductor layer in contact with the semiconductor laminated-layer structure such that the p-type semiconductor layer serves as a gate electrode. Further, the portion of the semiconductor laminated-layer structure which contacts with the p-type semiconductor layer is non-doped, but the portion can be of an n-type or p-type. In the first embodiment, the semiconductor laminated-layer structure is a nitride semiconductor, for example.

In the driving circuit according to the first embodiment, the switching device 1 is connected at its drain to a power supply (not illustrated) which outputs a voltage VM, further is connected at its gate to a gate control part 2 and, further, is connected at its source to one end of a load 8, and the other end of the load 8 is grounded. The gate control part 2 inputs gate drive signals GS to the gate of the switching device 1. The switching device 1 is connected, at its drain and its source, in a branched manner, to a voltage detection part 4 in a protection part 3.

In the first embodiment according to the present invention, the driving circuit is constituted by the gate control part 2, and the protection part 3 which includes the voltage detection part 4 and a holding part 7. Further, the semiconductor apparatus according to the first embodiment of the present invention is structured to include the aforementioned driving circuit, and the switching device 1 as the semiconductor device which is driven and controlled by the driving circuit. Further, in the first embodiment of the present invention, an operation-state detection part is constituted by the voltage detection part 4 which detects an operation state of the semiconductor device 1.

The voltage detection part 4 in the protection part 3 detects the drain-source voltage (Vds), by using an arbitrary detection means, only within intervals during which a determination command Signal MN being high (H) is formed and outputted by the gate control part 2. The voltage detection part 4 creates a voltage detection signal SV corresponding to the detected drain-source voltage (Vds) and outputs the voltage detection signal SV to the gate control part 2. If the drain-source voltage (Vds) satisfies a predetermined condition (if the drain-source voltage (Vds) exceeds an upper limit voltage Vx in the driving circuit according to the first embodiment) while the voltage detection signal SV is detected as described above, the voltage detection part 4 sends a voltage limit detection signal SVW being high (H) to the holding part 7. If the voltage limit detection signal SVW gets to be high (H) even just once, the holding part 7 sends a drive stop signal SB being high (H) to the gate control part 2, by using a means, such as a flip-flop and so on. In such a case, even if the voltage limit detection signal SVW which has been high (H) drops to a low (L), the drive stop signal SB is kept at the high (H) state. The gate control part 2 is structured such that the drive stop signal SB from the holding part 7 is inputted thereto and, also, an external drive stop signal EXSB is inputted thereto from outside of the apparatus. Accordingly, if at least one of the drive stop signal SB and the external drive stop signal EXSB gets to be high (H), the gate control part 2 drops the signal level of the gate drive signal GS to a ground level for stopping the driving of the switching device 1. In the aforementioned operations, the high (H) and the low (L) of signals are merely illustrative, and it is also possible to interchange the high (H) and the low (L) of signals for performing the same operations.

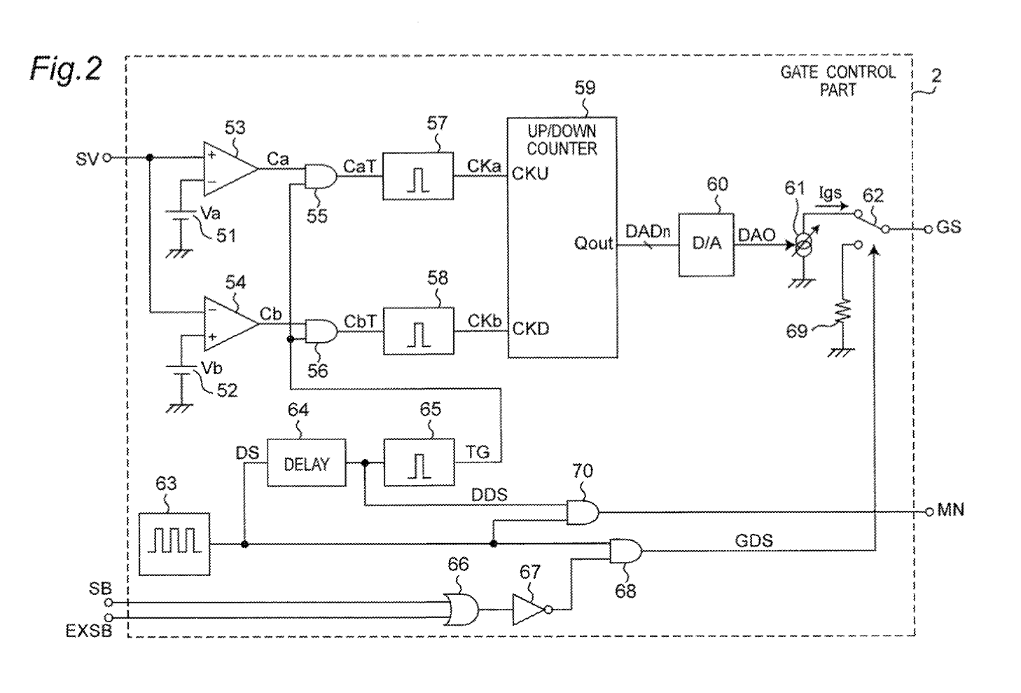

FIG. 2 is a block diagram illustrating the circuit structure of the gate control part 2 in the driving circuit according to the first embodiment of the present invention. In FIG. 2, the voltage detection signal SV is inputted to a positive terminal in a comparator 53, while a reference voltage source 51 which outputs a voltage Va is connected to a negative terminal thereof. Further, the voltage detection signal SV is inputted to a negative terminal of a comparator 54, while a reference voltage source 52 which outputs a voltage Vb is connected to a positive terminal thereof. The voltage Va outputted from the reference voltage source 51 is an upper changeover voltage (a first changeover reference voltage set value), while the voltage Vb outputted from the reference voltage source 52 is a lower changeover voltage (a second changeover reference voltage set value).

Output signals Ca and Cb from the comparators 53 and 54 are inputted to AND devices 55 and 56, respectively. The AND devices 55 and 56 perform AND-operations on the output signals Ca and Cb from the comparators 53 and 54 and signal outputs TG outputted from a single-pulse generator 65 and, further, output the results of the operations as signals CaT and CbT to single-pulse generators 57 and 58, respectively. The single-pulse generators 57, 58 and 65 are structured to generate only a single pulse having a predetermined width if the input signals thereto are changed from a low (L) to a high (H).

The single-pulse generators 57 and 58 output signals CKa and CKb to an up-down counter 59, if the signals CaT and CbT are inputted thereto from the AND devices 55 and 56. The signal CKa outputted from the single-pulse generator 57 is inputted to a count-up input CKU in the up-down counter 59. Further, the signal CKb outputted from the single-pulse generator 58 is inputted to a count-down input CKD in the up-down counter 59. The up-down counter 59 changes the output value DADn (“n” is a subscript) of a parallel output Qout of a logic signal therefrom, every time a pulse is inputted to the count-up input CKU or the count-down input CKD. For example, every time a pulse (CKa) is inputted to the count-up input CKU, the output value DADn is changed to DAD2, DAD3, DAD4, . . . in the mentioned order. On the contrary, every time a pulse (CKb) is inputted to the count-down input CKD, the output value DADn is changed to DAD4, DAD3, DAD2, . . . in the mentioned order. Further, the up-down counter 59 is set in such a way as to satisfy the relationship of DADn=DADn−1+An. In the first embodiment, the difference An between DADn and DADn−1 is constant regardless of “n”, but it can be varied depending on the value of “n”.

As described above, the up-down counter 59 has the function of forming a new parallel output Qout, by adding or subtracting a predetermined value to or from the value of the parallel output Qout before a pulse has been inputted to the count-up input CKU and the count-down input CKD. The parallel output Qout from the up-down counter 59 is inputted to a D/A converter 60, which converts the logic output value DADn of the parallel output Qout from the up-down counter 59 to a predetermined analog signal DAO and, then, outputs the analog signal. DAO. The analog signal DAO outputted from the D/A converter 60 is inputted to a discharge-type variable current source 61 under an analog signal control. The variable current source 61 outputs a current signal (Igs) as a gate drive signal GS to the gate of the switching device 1 through a switch 62.

As illustrated in FIG. 2, the gate control part 2 is provided with a driving-signal generator 63. The driving-signal generator 63 creates a drive signal DS which reflects desired operation pattern and operation timings for the switching device 1. The drive signal DS is inputted to a delay circuit 64, which delays the input signal by a predetermined time to create a delayed drive signal DDS. The delayed drive signal DDS is inputted to the single-pulse generator 65, which creates a signal TG including a single-pulse signal. The created signal. TG is inputted to the AND devices 55 and 56, as described above.

Further, the drive signal DS outputted from the drive-signal generator 63 is inputted to an AND device 68, which creates a signal GDS for driving the switch 62. When the signal GDS is high (H), the switch 62 causes the output from the variable current source 61 as the gate drive signal GS to be inputted to the gate of the switching device 1. On the other hand, when the signal GDS is low (L), a resistance 69 having a grounded one end is electrically connected to the gate of the switching device 1.

Further, the gate control part 2 is structured such that the drive signal DS from the drive-signal generator 63 and the delayed drive signal DDS from the delay circuit 64 are inputted to an AND device 70. The AND device 70 creates the determination command signal MN and inputs it to the voltage detection part 4 (see FIG. 1).

Further, in the gate control part 2, the drive stop signal SB from the aforementioned holding part 7 and the external drive stop signal EXSB are inputted to an OR device 66, and the OR device 66 inputs its output to the AND device 68 through an inverter (INV) device 67. The AND device 68 determines the logic multiplication of the output of the INV device 67 and the drive signal DS from the drive-signal generator 63 and, further, outputs the signal GDS for driving and controlling the switch 62.

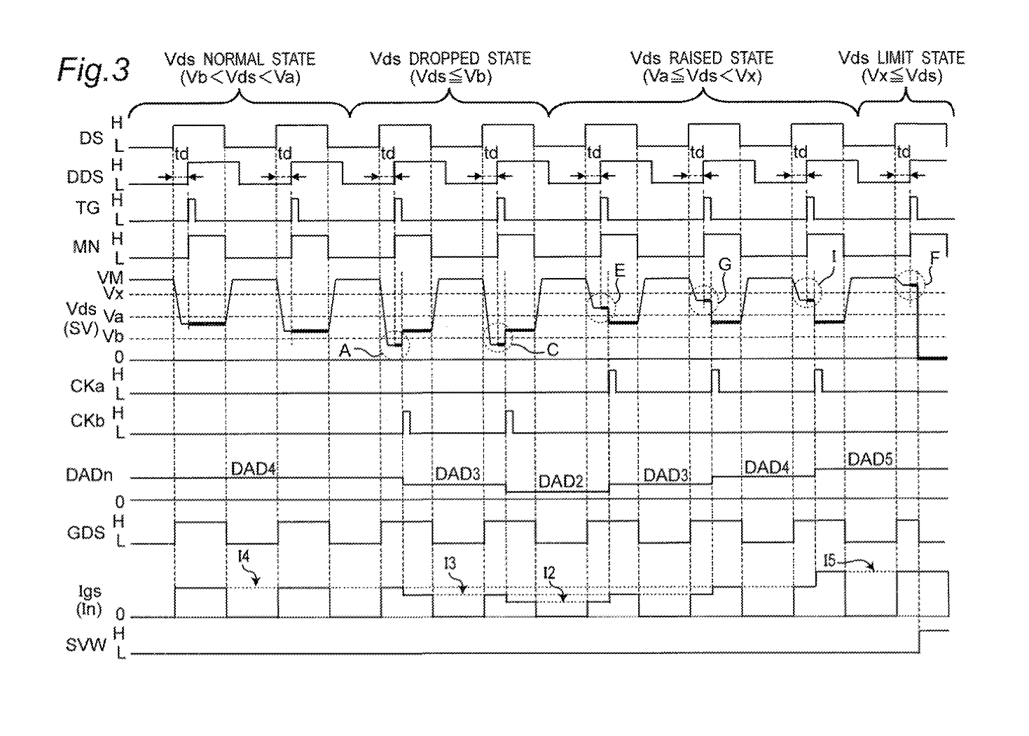

FIG. 3 is a waveform diagram illustrating main signals at respective portions in the semiconductor apparatus according to the first embodiment illustrated in FIG. 1 and FIG. 2. In the waveform diagram in FIG. 3, there are illustrated the waveforms of main signals at respective portions, in four operation conditions which are a Vds normal state, a Vds dropped state, a Vds raised state and a Vds limited state.

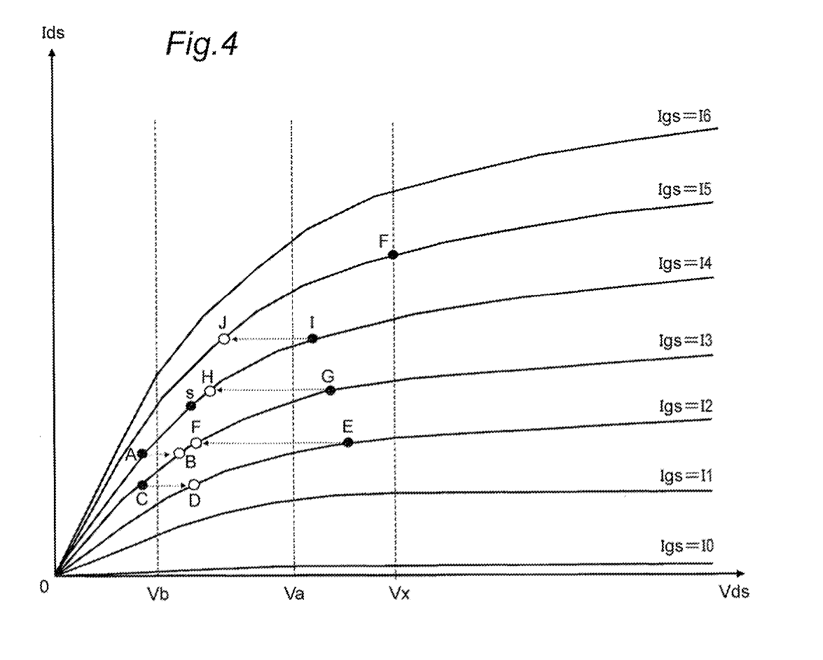

FIG. 4 is a characteristic diagram illustrating the relationship between the drain-source voltage (Vds) and the drain-source current (Ids) in the switching device 1 constituted by an FET employing a p-type region as its gate, illustrating transitions of the operation point of the switching device 1 according to the first embodiment.

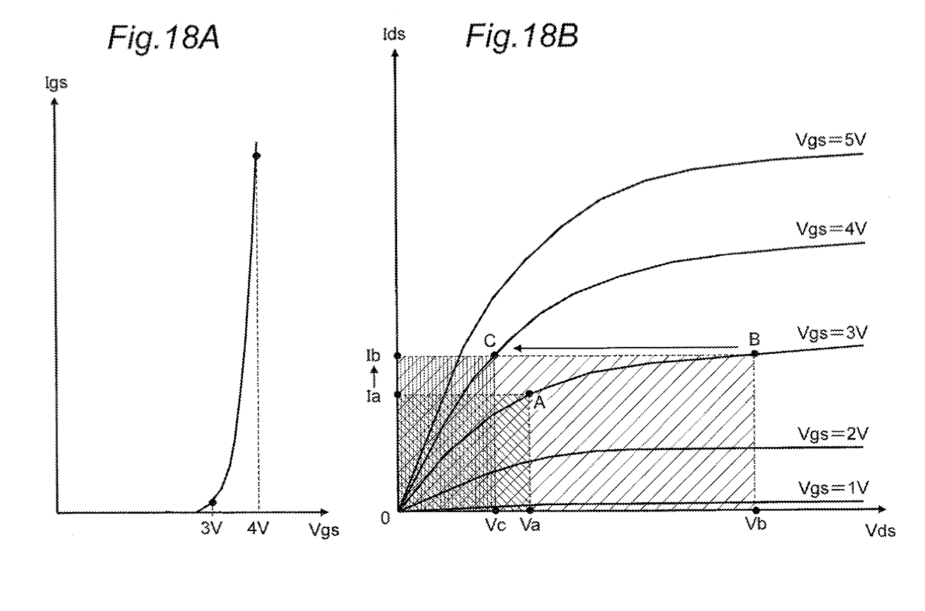

Further, as described with reference to FIG. 18A, in this switching device 1, there is uniquely a one-to-one correspondence between the gate-source voltage (Vgs) and the gate-source current (Igs). Further, this switching device 1 has a greater tendency to vary its forward characteristic, out of diode characteristics and, therefore, can be operated more stably by being controlled for each value of the gate-source current (Igs). Accordingly, the driving circuit according to the first embodiment is adapted to perform control for each value of the gate-source current (Igs). FIG. 4 illustrates the relationship between the drain-source voltage (Vds) and the drain-source current (Ids) for each value of the gate-source current (Igs).

[Operations of the Driving Circuit]

Hereinafter, there will be described operations of the driving circuit according to the first embodiment. Further, in the gate control part 2, the amount In (“n” is a subscript) of the output current (Igs) from the variable current source 61, which is the amount of current of the gate drive signal GS, corresponds to the output value DADn of the parallel output Qout from the up-down counter 59. Further, at the start of an operation (an initial state), the output value of the parallel output Qout from the up-down counter 59 is DAD4 and, along therewith, the output of the variable current source 61 is Igs=I4. At this time, the relationship between the drain-source voltage (Vds) and the drain-source current (Ids) is indicated by the position of a point S in FIG. 4. Further, in the first embodiment, the minimum and maximum values of the output current from the variable current source 61 are I2 and I5, respectively.

Further, at the start of the operation (the initial state), the voltage limit detection signal SVW outputted to the holding part 7 from the voltage detection part 4, and the drive stop signal SB are both low (L), namely there is a state where the holding part 7 is cleared. As can be clearly seen from FIG. 2, the external drive stop signal EXSB operates with the same polarity as that of the drive stop signal SB and, therefore, it is assumed that EXSB is L similarly to the drive stop signal SB at the start of the operation (the initial state), for convenience of description. Further, in the first embodiment, it is assumed that the drain-source voltage (Vds) equals to the voltage of the voltage detection signal SV when the determination command signal MN is H.

[Operations in Vds Normal States]

With reference to the waveform diagram illustrated in FIG. 3, there will be described operations of the driving circuit in a Vds normal state where the drain-source voltage (Vds) in the switching device 1 satisfies the relationship of Vb<Vds<Va within an interval during which the drive signal D is H.

Regarding the drive signal DS generated from the drive-signal generator 63, the signal GDS for driving the switch 62 has the same waveform as that of the drive signal DS, since the drive stop signal SB and the external drive stop signal EXSB are both low (L).

When the signal GDS for driving the switch 62 is high (H), the current outputted from the variable current source 61 is injected as the gate drive signal GS to the gate of the switching device 1, without being varied (Igs=I4 in FIG. 3, and the point S on Igs=I4 in FIG. 4). This brings the drain-source portion of the switching device 1 into an ON state, thereby bringing it into conduction. On the other hand, when the signal GDS is low (L), the resistance 69 is connected to the gate of the switching device 1, which drops the electric potential at the gate of the switching device 1, thereby bringing the switching device 1 into an OFF state.

The drive signal DS is inputted to the delay circuit 64 which creates a delayed drive signal DDS which has been delayed by a time interval td. The AND device 70 creates the determination command signal MN from the delayed drive signal DDS and the drive signal DS. The determination command signal MN has a pulse waveform corresponding to the drive signal DS but the portion thereof corresponding to the time interval td at its rising is eliminated. The aim of creating the determination command signal MN as described above is determining the drain-source voltage (Vds) with high accuracy after the transition from the transient state to a stable state, by avoiding voltage determination in momentary transient voltage states, such as during voltage ringing at the time of switching of the switching device 1.

While the determination command signal MN is high (H), the voltage detection part 4 determines the drain-source voltage (Vds). The voltage detection part 4 outputs, as the voltage detection signal SV, the thick-line portions of the waveform of “Vds” in FIG. 3. In this case, the comparators 53 and 54 determine that the voltage detection signal SV is equal to or larger than the lower changeover reference voltage Vb (the second changeover reference voltage set value) but is equal to or smaller than the upper changeover reference voltage (the first changeover reference voltage set value) Va, and the output signals Ca and Cb therefrom remains low (L).

The single-pulse generator 65 generates a signal TG having only a single pulse at the timing of the rise of the delayed drive signal DDS. In the first embodiment, at the timing of the signal TG, the magnitude of the drain-source voltage (Vds) is determined, and the gate drive current is changed. In the aforementioned operations in the Vds normal state, the output signals Cka and Ckb from the single-pulse generators 57 and 58 downstream of the AND devices 55 and 56 remain low (L), and the output value of the parallel output Qout from the up-down counter 59 is unchanged from DAD4.

[Operations in Vds Dropped States]

Next, there will be described operations of the driving circuit in a Vds dropped state where the drain-source voltage (Vds) in the switching device 1 satisfies the relationship of Vds≦Vb, within intervals during which the drive signal DS is H.

If the load 8 decreases to decrease the drain-source current (Ids), for example, the drain-source voltage (Vds) decreases along the characteristic curve for Igs=I4, in FIG. 4. Referring to FIG. 4, a transition occurs from the point S to a point: A, along the characteristic curve for Igs=I4. In this case, the comparator 53 determines that the voltage detection signal SV is equal to or smaller than the upper changeover reference voltage (the first changeover reference voltage set value) Va, and the output signal Ca from the comparator 53 is low (L) and, further, the comparator 54 determines that the voltage detection signal SV is equal to or smaller than the lower changeover reference voltage (the second changeover reference voltage set value) Vb, and the output signal Cb from the comparator 54 is high (H). As a result thereof, the output signal CbT from the AND device 56 also gets to be high (H), at the timing when the signal TG from the single-pulse generator 65 is high (H). Accordingly, the single-pulse generator 58 generates a signal CKb having a single pulse and inputs it to the count-down input CKD in the up-down counter 59. As a result thereof, the output value of the parallel output Qout from the up-down counter 59 decreases from DAD4 to DAD3. This decreases the output current from the variable current source 61, namely the gate driving current Igs, from I4 to I3. As a result thereof, the drain-source current (Ids) hardly changes, and the voltage detection signal. SV and the drain-source voltage (Vds) change to a value within the range from the voltage Vb to the voltage Va from the value within the range equal to or smaller than the voltage Vb. This change is a change in an enclosure A indicated by a broken line in FIG. 3, indicating a transition of the operation point from the point A to a point B in FIG. 4. With the aforementioned transition operation, even though there is a slight increase of the loss (the electric power consumption) in the switching device 1, which is expressed as the product of the drain-source voltage (Vds) and the drain-source current (Ids), the gate driving current (Igs) can be reduced. Therefore, with the driving circuit according to a first embodiment, it is possible to realize speed-up of switching operations and reduction of the loss in the driving circuit itself in low-load states.

When the drain-source voltage (Vds) is further decreased, the processing for the aforementioned transition operation is repeated. For example, referring to FIG. 3, the drain-source voltage (Vds) changes as in an enclosure C indicated by a broken line, and, referring to FIG. 4, the operation point shifts from a point C to a point D, thereby reducing the gate driving current (Igs) from I3 to I2. By performing the transition operation as described above, it is possible to realize speed-up of switching operations and reduction of the loss in the driving circuit itself, in low-load states, when Vds drops.

[Operations in Vds Raised States]

Subsequently, there will be described operations of the driving circuit in a Vds raised state where the drain-source voltage (Vds) in the switching device 1 satisfies the relationship of Va≦Vds<Vx, within intervals during which the drive signal DS is H.

If the load 8 increases to increase the drain-source current (Ids), for example, this induces a state illustrated in an enclosure E indicated by a broken line in FIG. 3. This change is a state where the drain-source voltage (Vds) increases along the characteristic curve for Igs=I2, and a transition occurs to a point F from a point E on the characteristic curve for Igs=I2, in FIG. 4. In this case, the comparator 53 determines that the voltage detection signal SV (Vds) is equal to or larger than the upper changeover reference voltage (the first changeover reference voltage set value) Va, and the comparator 53 outputs the output signal Ca being high (H). Further, the comparator 54 determines that the voltage detection signal SV (Vds) is equal to or larger than the lower changeover reference voltage Vb, and the comparator 54 outputs the output signal Cb being low (L). The output signal CaT from the AND device 55 gets to be high (H), at the timing when the signal TG from the single-pulse generator 65 is high (H). Accordingly, the single-pulse generator 57 generates a signal CKa having a single pulse and inputs it to the count-up input CKU in the up-down counter 59. As a result thereof, the output value of the parallel output Qout from the up-down counter 59 increases from DAD2 to DAD3. Along therewith, the output current from the variable current source 61 increases from I2 to I3. As a result thereof, the drain-source current (Ids) hardly changes, and the voltage detection signal. SV and the drain-source voltage (Vds) change to a value within the range from the voltage Vb to the voltage Va from the value within the range equal to or larger than the voltage Va. This change indicates the transition of the operation point from the point E to the point F in FIG. 4. As described above, in operations for supplying a necessary gate driving current (Igs) in a high-load state, it is possible to largely reduce the loss (the electric power consumption) in the switching device 1, which is expressed as the product of the drain-source voltage (Vds) and the drain-source current (Ids).

When the drain-source voltage (Vds) is further increased, the processing for the aforementioned transition operation is repeated. For example, referring to FIG. 3, the drain-source voltage (Vds) changes as in enclosures G and I indicated by broken lines, and, referring to FIG. 4, the operation point shifts from a point G to a point H to increase the gate driving current (Igs) from I3 to I4 and, further, the operation point shifts from a point I to a point to increase the gate driving current (Igs) from I4 to I5. By performing the transition operation as described above, it is possible to reduce the loss (the electric power consumption) in the switching device 1 with a gate driving current (Igs) necessary in high-load states, when Vds rises.

[Operations in Vds Limited States]

Next, there will be described operations of the driving circuit in a Vds limited state where the drain-source voltage (Vds) in the switching device 1 satisfies the relationship of Vx≦Vds, within intervals during which the drive signal DS is H.

If the load 8 further increases to further increase the drain-source current (Ids), for example, this induces a change as in an enclosure F indicated by a broken line in FIG. 3. This change is a state where the drain-source voltage (Vds) increases along the characteristic curve for Igs=I5 and shifts to an upper voltage (an upper-limit reference voltage set value) at a point F in FIG. 4. In this case, the gate driving current (Igs) has a maximum value of I5 and, therefore, the gate driving current (Igs) cannot increase any more. This largely increases the loss (the electric power consumption) in the switching device 1, which is expressed as the product of the drain-source voltage (Vds) and the drain-source current (Ids). With operations of the voltage detection part 4, if the drain-source voltage (Vds) becomes equal to or larger than the upper-limit voltage Vx during switching operations, the voltage limit detection signal SVW immediately gets to be high (H). Thus, the holding part 7 fixes the drive stop signal SB outputted therefrom to be high (H). As a result thereof, in the gate control part 2 illustrated in FIG. 2, the INV device 67 outputs a low (L), and the signal GDS outputted from the AND device 68 is fixed to be low (L), regardless of the waveform of the drive signal DS from the driving-signal generator 63. This causes the switch 62 to be kept connected to the resistance 69, which shifts the gate drive signal GS and the electric potential at the gate of the switching device 1 to the ground electric potential, thereby bringing the switching device 1 into a state where it performs no switching operations.

Further, although it is assumed that the relationship between the drain-source voltage (Vds) and the voltage detection signal SV is such that they are equal to each other when the determination command signal MN is H in the first embodiment, the way of transmission of the voltage detection signal SV can be arbitrary, provided that it is possible to maintain the relationship between the drain-source voltage (Vds) and the reference voltages Va and Vb and the like, in the first embodiment. Further, the first embodiment is one of examples for realizing the present invention, and it is also possible to employ other means and methods which can offer the same functions and effects with other ways than that of the first embodiment.

Further, in the first embodiment, Va is set as the upper changeover determination reference voltage (the first changeover reference voltage set value) for the gate driving current (Igs), and the voltage Vx is set as the upper-limit voltage (the upper-limit reference voltage set value) for the drain-source voltage (Vds). This is for differentiating the range within which the switching device 1 is controlled in loss from the range within which the switching device 1 is operated within a safe operation area by defining a maximum value of the drain-source voltage (Vds) in ON states. The driving circuit according to the first embodiment has the function of changing over the gate driving circuit (Igs) and, also, the function of detecting the voltage limit of the drain-source voltage (Vds) and generating the drive stop signal SB, as different functions. However, it is also possible to eliminate the function of detecting the upper-limit voltage Vx in the drain-source voltage (Vds) in the voltage detection part 4, if the aforementioned ranges are equal to each other. For example, it is also possible to employ a method which outputs a voltage limit detection signal SVW if the drain-source voltage (Vds) reaches the upper changeover reference voltage (the first changeover reference voltage set value) Va, when the parallel output Qout from the up-down counter 59 has a maximum value.

Further, although in the first embodiment, for example, the reference voltages Va and Vb are fixed, the reference voltage sources 51 and 52 can be variable voltage sources which are variable along with the signal DAO outputted from the D/A converter 60, in order to control the loss in the switching device 1 with higher accuracy. Further, the voltage detection part 4 can be adapted to output a voltage detection signal SV having time-averaged values and, also, the holding part 7 can be adapted to make the drive stop signal SB high (H) if the voltage limit detection signal SVW has been high (H) for a certain time period or longer, in order to enable virtually neglecting increases of the drain-source voltage (Vds) within permissible short time periods, such as noises.

Further, while, in the first embodiment, the driving circuit has been described with respect to an FET which employs a p-type region as its gate as a semiconductor device, the first embodiment can be also applied to an FET which employs a Schottky electrode as its gate to offer the same excellent effects. This is because an FET employing a Schottky electrode may also be brought into a state where a diode is formed between the gate and the source, thereby inducing the same problems.

Although the driving circuit according to the first embodiment is adapted to control the gate current with a variable current source according to the drain-source voltage (the drain-source current, the electric power consumption between the input and output terminals in the switching device, and the like), it is also possible to control the gate voltage, similarly, using a variable voltage source to offer the same effects.

Further, the driving circuit according to the first embodiment is an example for realizing the present invention, and the present invention is intended to cover other means and methods than those described in the first embodiment, provided that these means and methods have the same technical characteristics and offer the same functions and effects.

The driving circuit having the aforementioned structure according to the first embodiment is structured to detect an increase of the electric power consumption in a switching device from the voltage between input and output terminals in the switching device and to accumulatively increase or decrease the gate current according to the increase or decrease of the electric power consumption, in cases of driving the switching device, such as an FET employing a p-type region or a Schottky electrode as its gate. As a result thereof, with the structure of the driving circuit according to the first embodiment, it is possible to reduce the electric power consumption in high load states and reduce the loss in the driving circuit in low load states and, further, it is possible to protect the switching device against excessive voltage states between the input and output terminals of the switching device. Accordingly, it is possible to provide a driving circuit having excellent safety and reliability and being capable of energy saving and, also, to provide a semiconductor apparatus using this driving circuit, with largely reduced fabrication costs.

### Second Embodiment

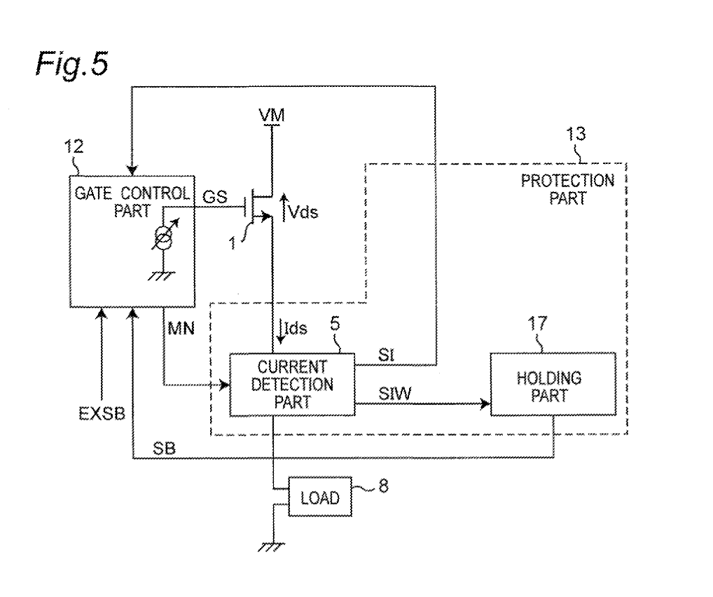

FIG. 5 is a block diagram illustrating the circuit structures of a driving circuit and a semiconductor apparatus including the driving circuit, according to a second embodiment of the present invention. Further, the second embodiment will be also described with respect to an FET which employs a p-type region as its gate, as a switching device 1 which is a semiconductor device which is driven and controlled by the driving circuit. However, it goes without saying that the second embodiment can be also applied to an FET employing a Schottky electrode as its gate and other semiconductor devices to offer the same effects. In the following description of the second embodiment, components having the same functions and structures as those of the driving circuit and the semiconductor apparatus according to the first embodiment will be designated by the same reference characters and will not be described.

Referring to FIG. 5, a gate control part 12 is connected to the gate of the switching device 1, which is an FET employing a p-type region as its gate. Further, the switching device 1 is connected at its drain to a power supply (not illustrated) which outputs a voltage VM and, also, is connected at its source to one end of a load 8 through a current detection part 5, and the other end of the load 8 is grounded. The gate control part 12 inputs a gate drive signal GS to the gate of the switching device 1. The current detection part 5 in a protection part 13 determines the drain-source current (Ids), with an arbitrary a means, such as a shunt resistance for an electric potential difference or a Hall device for a Hall voltage, only during intervals during which a determination command signal MN formed by the gate control part 12 is high (H). The current detection part 5 creates a current detection signal SI as a current signal corresponding to the magnitude of the drain-source current (Ids) and, further, sends the current detection signal SI to the gate control part 12. If the drain-source current (Ids) satisfies a predetermined condition (if the drain-source current (Ids) exceeds a current Ix in the driving circuit according to the second embodiment) while the current detection signal SI is detected as described above, the current detection part 5 sends a current limit detection signal SIW being high (H) to a holding part 17. If the current limit detection signal SIW gets to be high (H) even just once, the holding part 17 sends a drive stop signal SB being high (H) to the gate control part 12, by using a means, such as a flip-flop and so on. In such a case, even if the current limit detection signal SIW which has been high (H) drops to a low (L), the drive stop signal SB is maintained at the high (H). The gate control part 12 is structured such that the drive stop signal SB from the holding part 17 is inputted thereto and, also, an external drive stop signal EXSB from outside of the apparatus is inputted thereto. Accordingly, if at least one of the drive stop signal SB and the external drive stop signal EXSB gets to be high (H), the gate control part 12 drops the signal level of the gate drive signal GS to a ground level for stopping the driving of the switching device 1.

In the aforementioned operations, the high (H) and the low (L) of signals are merely illustrative, and it is also possible to interchange the high (H) and the low (L) of signals for performing the same operations.

Further, in the second embodiment according to the present invention, the driving circuit is constituted by the gate control part 12, and the protection part 13 which includes the current detection part 5 and the holding part 17. Further, the semiconductor apparatus according to the second embodiment of the present invention is structured to include the aforementioned driving circuit, and the switching device 1 as a semiconductor device which is driven and controlled by the driving circuit. Further, in the second embodiment of the present invention, an operation-state detection part is constituted by the current detection part 5 which detects an operation state of the semiconductor device 1.

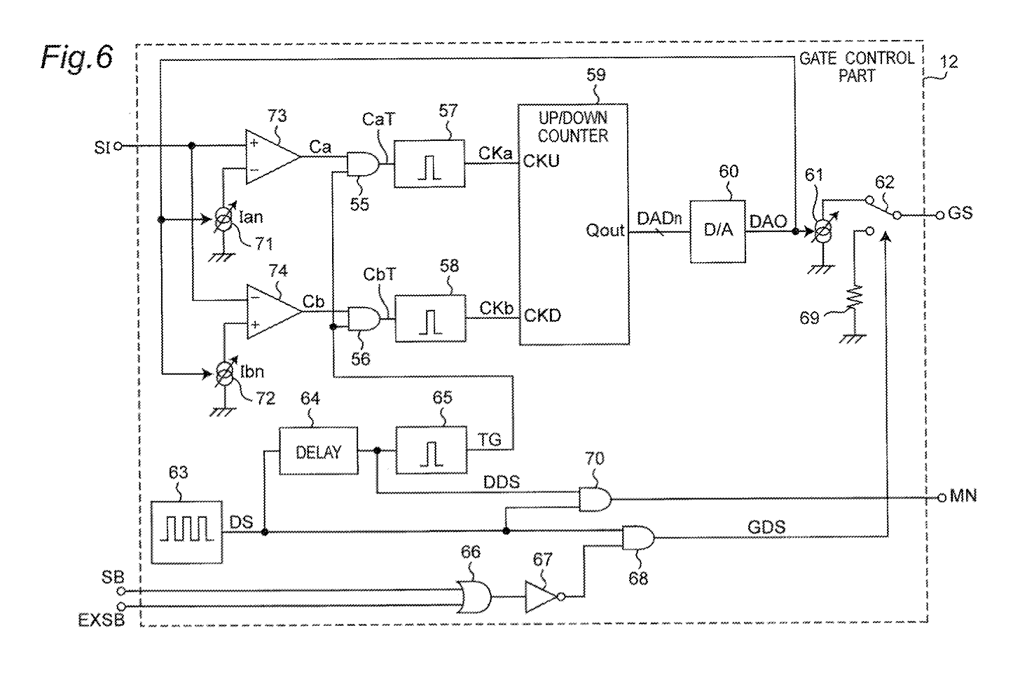

Hereinafter, there will be described the driving circuit according to the second embodiment, regarding the structure and operations of the gate control part 12 which are largely different from those of the driving circuit according to the first embodiment. FIG. 6 is a block diagram illustrating the circuit structure of the gate control part 12 according to the second embodiment of the present invention. In FIG. 6, the current detection signal SI is inputted to a positive terminal in a current-comparison type comparator 73, while a variable current source 71 which outputs a current Ian (“n” is a subscript) is connected to a negative terminal thereof. Further, the current detection signal SI is inputted to a negative terminal of a current-comparison type comparator 74, while a variable current source 72 which outputs a current Ibn (“n” is a subscript) is connected to a positive terminal thereof. Both the variable current sources 71 and 72 are of a discharge type and are adapted to output currents Ian and Ibn corresponding to the analog signal DAO outputted from a D/A converter 60, namely the logic output value DADn of a parallel output Qout from an up-down counter 59. In the gate control part 12 according to the second embodiment, portions other than the current-comparison type comparators 73 and 74 and the variable current sources 71 and 72 have the same structures as those in the gate control part 2 according to the first embodiment and perform the same operations thereas.

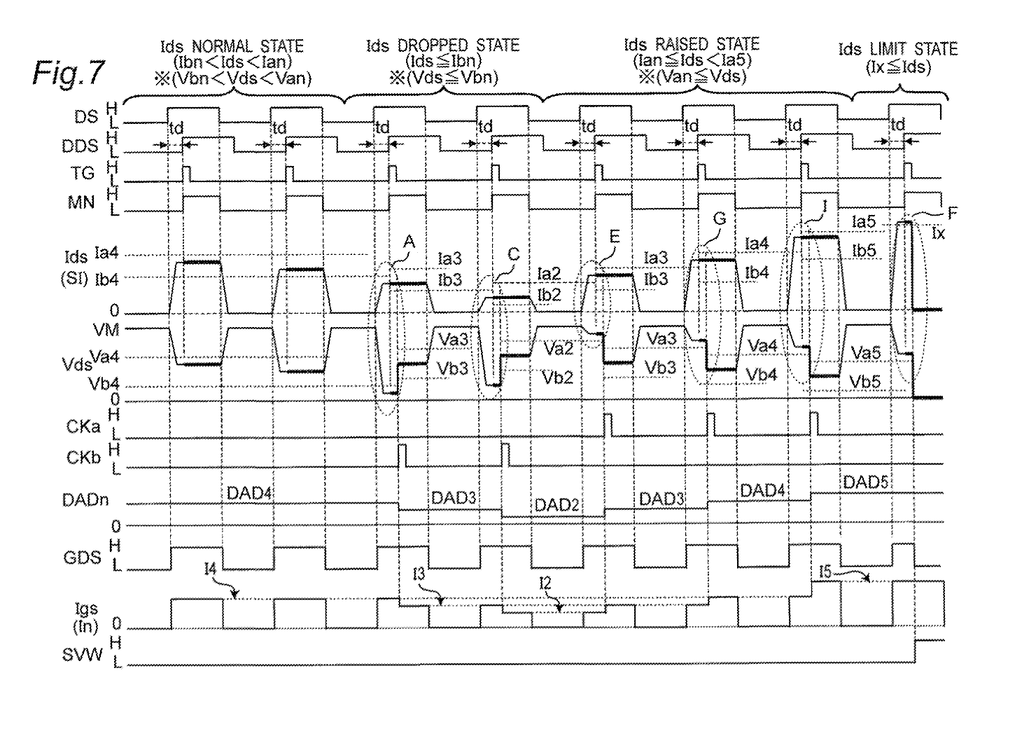

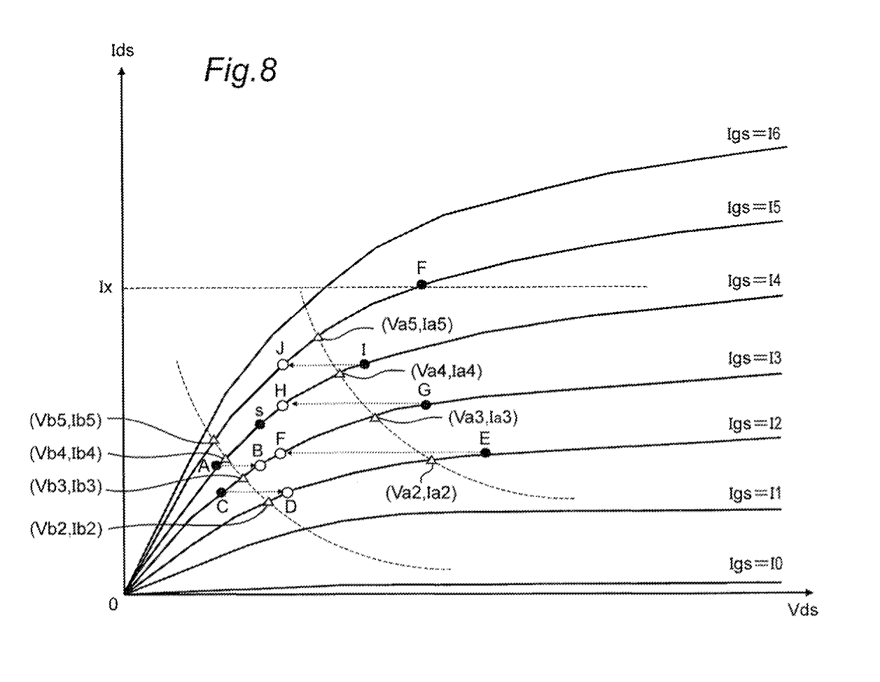

FIG. 7 is a waveform diagram illustrating main signals at respective portions in the semiconductor apparatus according to the second embodiment illustrated in FIG. 5 and FIG. 6. FIG. 8 is a characteristic diagram illustrating the relationship between the drain-source voltage (Vds) and the drain-source current (Ids) in the switching device 1, which is an FET employing a p-type region as its gate, illustrating transitions of the operation point of the switching device 1 according to the second embodiment. Here, there is illustrated the relationship between the drain-source voltage (Vds) and the drain-source current (Ids) for each value of the gate-source current (Igs), similarly to in FIG. 4.

[Operations of the Driving Circuit]

Hereinafter, there will be described operations of the driving circuit according to the second embodiment. Further, in the gate control part 12, the amount In (“n” is a subscript) of the output current (Igs) from the variable current source 61, which is the amount of current of the gate drive signal GS, corresponds to the output value DADn of the parallel output Qout from the up-down counter 59. Further, at the start of an operation (an initial state), the output value of the parallel output. Qout from the up-down counter 59 is DAD4 and, along therewith, the output of the variable current source 61 is Igs=I4. It is assumed that, at this time, the relationship between the drain-source voltage (Vds) and the drain-source current (Ids) is indicated by the position of a point S in FIG. 8. Further, in the second embodiment, the minimum and minimum values of the output current from the variable current source 61 are I2 and I5, respectively.

Further, at the start of the operation (the initial state), the current limit detection signal SIP; outputted from the current detection part 5 to the holding part 17 and the drive stop signal. SB are both low (L), namely there is a state where the holding part 17 is cleared. As can be clearly seen in FIG. 6, the external drive stop signal EXSB operates with the same polarity as that of the drive stop signal SB and, therefore, it is assumed that EXSB is L similarly to the drive stop signal SB at the start of the operation (the initial state), for convenience of description. Further, in the second embodiment, it is assumed that the drain-source current (Ids) equals to the current of the current detection signal SI when the determination command signal MN is H, for convenience of description.

[Operations in Ids Normal States]

With reference to the waveform diagram illustrated in FIG. 7, at first, there will be described operations of the driving circuit in an Ids normal state where the drain-source current (Ids) in the switching device 1 satisfies the relationship of Ibn<Ids<Ian, within an interval during which the drive signal DS is H.

While the determination command signal MN is high (H), the current detection part 5 determines the drain-source current (Ids). The current detection part 5 outputs, as the current detection signal SI, the thick-line portions of the waveform of “Ids” in FIG. 7. In this case, the comparators 73 and 74 determine that the current detection signal SI is equal to or larger than a lower changeover reference current (a second changeover reference current set value) Ib4 for Igs=I4 but is equal to or smaller than an upper changeover reference current (a first changeover reference current set value) Ia4 for Igs=I4, and the respective output signals Ca and Cb remains low (L). Therefore, the output value of the parallel output Qout from the up-down counter 59 is unchanged from DAD4, thereby maintaining the gate driving current (Igs) at Igs=I4. In this case, in FIG. 8, when the reference currents Ia4 and Ib4 from the reference current sources 71 and 72 are determined, the drain-source voltage (Vds) can be uniquely determined with a one-to-one relationship with Va4 and Vb4, which indicates that the loss (the electric power consumption) of the switching device 1 falls within the range from Vb4-Ib4 to Va4-Ia4. In other words, it can be said that the drain-source voltage (Vds) satisfies the relationship of Vbn<Vds<Van within the range from Vb4-Ib4 to Va4-Ia4.

[Operations in Ids Dropped States]

Next, there will be described operations of the driving circuit in an Ids dropped state where the drain-source current (Ids) in the switching device 1 satisfies the relationship of Ids≦Ibn, within an interval during which the drive signal DS is H. As described above, when the reference currents Ian and Ibn from the reference current sources 71 and 72 are determined, the drain-source voltage (Vds) can be also uniquely determined with a one-to-one relationship with Van and Vbn and, therefore, it can be said that the drain-source voltage (Vds) satisfies the relationship of Vbn≦Vds in Ids dropped States.

If the load 8 decreases, this decreases the drain-source current (Ids) along the characteristic curve for Igs=I4, in FIG. 8, for example, thereby causing a transition from the point S to a point A along the characteristic curve for Igs=I4. In this case, the comparator 73 determines that the current detection signal SI is equal to or smaller than the upper changeover reference current (the first changeover reference current set value) Ia4, and the comparator 73 generates an output signal Ca being low (L). Further, in this case, the comparator 74 determines that the current detection signal SI is equal to or smaller than the lower changeover reference current (the second changeover reference current set value) Ib4, and the comparator 74 generates an output signal Cb being high (H). As a result thereof, the output signal CbT from the AND device 56 also gets to be high (H), at the timing when the single-pulse generator 65 generates a signal TG being high (H). Accordingly, the single-pulse generator 58 generates a signal CKb having a single pulse and inputs it to the count-down input CKD in the up-down counter 59. As a result thereof, the output value of the parallel output Qout of the up-down counter 59 decreases from DAD4 to DAD3. Along therewith, the output current from the variable current source 61, namely the gate driving current Igs, decreases from I4 to I3. As a result thereof, the drain-source current (Ids) changes as in an enclosure A indicated by a broken line in FIG. 7, thereby shifting the operation point from the point A to a point B in FIG. 8. With the aforementioned transition operation, while the drain-source current (Ids) hardly changes, the drain-source voltage (Vds) increases. Even though there is a slight increase of the loss in the switching device 1, which is expressed as the product of the drain-source voltage (Vds) and the drain-source current (Ids), the gate driving current (Igs) is reduced. Therefore, with the driving circuit according to the second embodiment, it is possible to realize speed-up of switching operations and reduction of the loss in the driving circuit itself in low-load states.

When the drain-source current (Ids) is further decreased, the processing for the aforementioned transition operation is repeated. For example, referring to FIG. 7, the drain-source current (Ids) changes as in an enclosure C indicated by a broken line, and, referring to FIG. 8, the operation point shifts from a point C to a point D, thereby reducing the gate driving current (Igs) from I3 to I2. By performing the transition operation as described above, it is possible to realize speed-up of switching operations and reduction of the loss in the driving circuit itself in low-load states, when Ids drops.

[Operations in Ids Raised States]

Subsequently, there will be described operations of the driving circuit in an Ids raised state where the drain-source current (Ids) in the switching device 1 satisfies the relationship of Ian≦Ids<Ia5, within an interval during which the drive signal DS is H. As described above, when the reference currents Ian and Ibn from the reference current sources 71 and 72 are determined, the drain-source voltage (Vds) can be also uniquely determined with a one-to-one relationship with Van and Vbn and, therefore, it can be said that the drain-source voltage (Vds) satisfies the relationship of Van≦Vds in Ids raised states.

If the load 8 increases, this increases the drain-source current (Ids) along the characteristic curve for Igs=I2, in FIG. 8, for example, which causes a transition from a point D to a point E along the characteristic curve for Igs=I2. In this case, the comparator 73 determines that the current detection signal SI is equal to or larger than the upper changeover reference current (the first changeover reference current set value) Ia2 and, further, the comparator 74 determines that the current detection signal SI is equal to or larger than the lower changeover reference current (the second changeover reference current set value) Ib2, so that the comparator 73 generates an output signal Ca being high (H), and the comparator 74 generates an output signal Cb being low (L). The output signal CaT from the AND device 55 gets to be high (H), at the timing when the single-pulse generator 65 generates a signal TG being high (H). Accordingly, the single-pulse generator 57 generates a signal CKa having a single pulse and inputs it to the count-up input CKU in the up-down counter 59. As a result thereof, the output value of the parallel output Qout of the up-down counter 59 increases from DAD2 to DAD3. Along therewith, the output current from the variable current source 61 increases from I2 to I3. As a result thereof, the drain-source voltage (Vds) changes as in an enclosure E indicated by a broken line in FIG. 7, thereby shifting the operation point from a point E to a point F in FIG. 8. With the transition operation, the drain-source voltage (Vds) is largely decreased, while the drain-source current (Ids) hardly changes. This largely decreases the loss (the electric power consumption) of the switching device 1, which is expressed as the produce of the drain-source voltage (Vds) and the drain-source current (Ids).

When the drain-source voltage (Vds) is further increased, the processing for the aforementioned transition operation is repeated. For example, referring to FIG. 7, the drain-source voltage (Vds) changes as in enclosures G and I indicated by broken lines, and, referring to FIG. 8, the operation point shifts from a point G to a point H and from a point I to a point J, which increases the gate driving current (Igs) from I3 to I4 and from I4 to I5. By performing the transition operation as described above, it is possible to reduce the loss (the electric power consumption) in the switching device 1 with a gate driving current (Igs) necessary in high-load states, when Ids rises.

[Operations in Ids Limited States]

Next, there will be described operations of the driving circuit in an Ids limited state where the drain-source current (Ids) in the switching device 1 satisfies the relationship of Ix<Ids, within an interval during which the drive signal DS is H.

If the load 8 further increases to further increase the drain-source current (Ids), for example, this induces a change as in an enclosure F indicated by a broken line in FIG. 7. This change is a state where the drain-source voltage (Vds) increases along the characteristic curve for Igs=I5 and shifts to a point F, for example. In this case, the gate driving current (Igs) has a maximum value of I5 and, therefore, the gate driving current (Igs) cannot increase any more. This largely increases the loss (the electric power consumption) in the switching device 1, which is expressed as the product of the drain-source voltage (Vds) and the drain-source current (Ids). With operations of the current detection part 5, if the drain-source current (Ids) becomes equal to or larger than the upper-limit current Ix during switching operations, the current limit detection signal SIW immediately gets to be high (H). Thus, the holding part 17 fixes the driving stop signal SB outputted therefrom to be high (H). As a result thereof, in the gate control part 12 illustrated in FIG. 6, the INV device 67 outputs a low (L), which fixes the signal GDS outputted from the AND device 68 to be low (L), regardless of the waveform of the drive signal DS from the driving-signal generator 63. This causes the switch 62 to be kept connected to the resistance 69, which shifts the gate drive signal GS and the electric potential at the gate of the switching device 1 to the ground electric potential, thereby bringing the switching device 1 into a state where it performs no switching operation.

Further, “Van” and “Ian” in FIG. 8 can be set such that the electric power consumption (Van Ian) has a predetermined value, regardless of the value of “n”, which can cause the loss of the switching device 1 to have a constant maximum value, regardless of the magnitude of the gate driving current. Further, although it is assumed that the relationship between the drain-source current (Ids) and the current detection signal SI is such that they are equal to each other when the determination command signal MN is H, in the second embodiment, the way of transmission of the current detection signal SI can be arbitrary, provided that it is possible to maintain the relationship between the drain-source current (Ids) and the reference currents Ia and Ib and the like, in the driving circuit according to the second embodiment.

Further, in the driving circuit according to the second embodiment, the current detection part 5 can be also adapted to output a current detection signal SI having time-averaged values and, also, the holding part 17 can be adapted to make the drive stop signal SB high (H) if the current limit detection signal SIW has been high (H) for a certain time period or longer, in order to enable the driving circuit to virtually neglect current increases within permissible short time periods.

Further, while the driving circuit according to the second embodiment has been described with respect to an FET which employs a p-type region as its gate, as a semiconductor device, the driving circuit according to the second embodiment can be also applied to an FET which employs a Schottky electrode as its gate to offer the same excellent effects. This is because an FET employing a Schottky electrode can be also brought into a state where a diode is formed between its gate and its source, thereby inducing the same problems.

Although the driving circuit according to the second embodiment is adapted to control the gate current with a variable current source, according to the drain-source current, it is also possible to control the gate voltage using a variable voltage source and the like to offer the same effects.

Further, the driving circuit according to the second embodiment is merely an example for realizing the present invention, and the present invention is intended to cover other means and methods than those described in the second embodiment, provided that these means and methods have the same technical characteristics and offer the same functions and effects.

The driving circuit having the aforementioned structure according to the second embodiment is structured to detect an increase of the electric power consumption in a switching device from the current between input and output terminals in the switching device and to accumulatively increase on decrease the gate current according to the increase or decrease of the current, in cases of driving the switching device, such as an FET employing a p-type region or a Schottky electrode as its gate. As a result thereof, with the structure of the driving circuit according to the second embodiment, it is possible to enable reduction of the electric power consumption in high-load states, reduction of the loss in the driving circuit in low-load states, and protection of the switching device against excessive currents applied thereto. Consequently, it is possible to provide a driving circuit having excellent safety and reliability and being capable of energy saving and, also, to provide a semiconductor apparatus using this driving circuit, with largely reduced fabrication costs.

### Third Embodiment

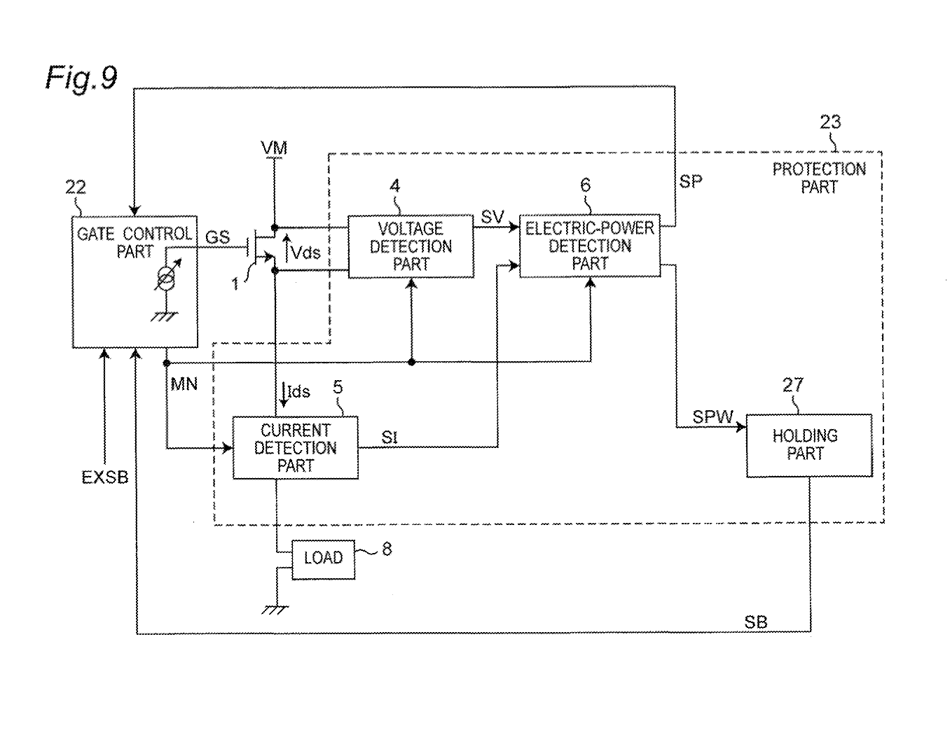

FIG. 9 is a block diagram illustrating the circuit structures of a driving circuit and a semiconductor apparatus including the driving circuit, according to a third embodiment of the present invention. Further, the third embodiment will be also described with respect to an FET employing a p-type region as its gate, as a switching device 1 which is a semiconductor device which is driven and controlled by the driving circuit. However, it goes without saying that the third embodiment can be also applied to an FET employing a Schottky electrode as its gate and other semiconductor devices to offer the same effects. In the following description of the third embodiment, components having the same functions and structures as those of the driving circuits and the semiconductor apparatuses according to the first and second embodiments will be designated by the same reference characters and will not be described.

The driving circuit according to the third embodiment is provided with the same voltage detection part 4 as that in the driving circuit according to the first embodiment, and the same current detection part 5 as that of the second embodiment and, further, is provided with an electric-power detection part 6 for calculating electric power based on a voltage detection signal SV and a current detection signal SI.

Referring to FIG. 9, the electric-power detection part 6 in a protection part 23 extracts the voltage detection signal SV and the current detection signal SI and performs operation processing on these two signals (SV, SI) with an operation device, such as an analog multiplication circuit or a microcomputer, only during intervals during which a gate control part 22 generates a determination command signal MN being high (H). In the operation processing, the electric-power detection part 6 creates an electric-power detection signal SP, as a voltage signal corresponding to the product of the drain-source voltage (Vds) and the drain-source current (Ids) in the switching device 1, and, further, transmits it to the gate control part 22. If the electric-power detection signal (SP) detected as described above exceeds a predetermined value (if the electric-power detection signal SP exceeds a limit voltage Vy in the driving circuit according to the third embodiment), the electric-power detection part 6 transmits an electric-power limit detection signal SPW being high (H) to a holding part 27. If the electric-power limit detection signal SPW gets to be high (H) even just once, the holding part 27 sends a drive stop signal SB being high (H) to the gate control part 22, by using a means, such as a flip-flop and so on. In such a case, even if the electric-power limit detection signal SPW which has been high (H) drops to a low (L), the drive stop signal SB is maintained at the high (H). If at least one of the drive stop signal SB and an external drive stop signal EXSB gets to be high (H), the gate control part 22 drops the signal level of the gate drive signal GS to a ground level for stopping the driving of the switching device 1.

In the aforementioned operations, the high (H) and the low (L) of signals are merely illustrative, and it is also possible to interchange the high (H) and the low (L) of signals for performing the same operations.

Further, in the third embodiment, the driving circuit is constituted by the gate control part 22 and the protection part 23 which includes the voltage detection part 4, the current detection part 5, the electric-power detection part 6, and the holding part 27. Further, the semiconductor apparatus according to the third embodiment of the present invention is structured to include the aforementioned driving circuit, and the switching device 1 as a semiconductor device which is driven and controlled by the driving circuit. Further, in the third embodiment of the present invention, an operation-state detection part is constituted by the voltage detection part 4, the current detection part 5 and the electric-power detection part 6 which detect an operation state of the semiconductor device 1.

The gate control part 22 has substantially the same circuit structure as that of the gate control part 2 illustrated in FIG. 2 according to the first embodiment and also is adapted to perform substantially the same operations thereas, and is different therefrom only in voltages Va and Vb from reference voltage sources 51 and 52.

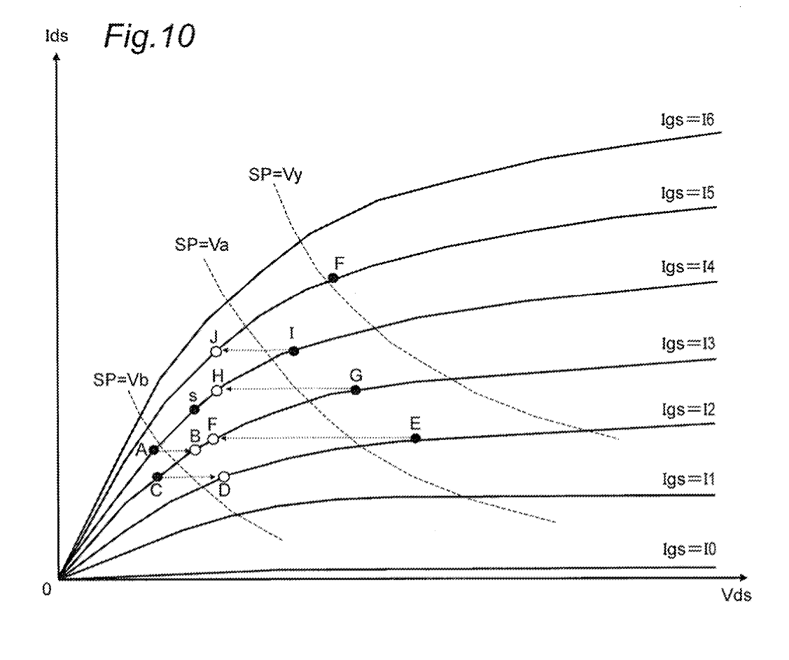

FIG. 10 is a characteristic diagram illustrating the relationship between the drain-source voltage (Vds) and the drain-source current (Ids) in the FET switching device which employs a p-type region as its gate, illustrating transitions of the operation point of the switching device 1 according to the third embodiment. However, similarly to in FIG. 4, there is illustrated the relationship between the gate-source voltage (Vgs) and the gate-source current (Igs) for each value of the gate-source current (Igs). In FIG. 10, the respective curves represented as SP=Va, Vb and Vy are curves indicating relationships which make the loss of the switching device constant at the voltages Va, Vb and Vy, wherein the loss of the switching device is the product of the drain-source voltage (Vds) and the drain-source current (Ids).

[Operations of the Driving Circuit]

Hereinafter, there will be described operations of the driving circuit according to the third embodiment, with reference to FIG. 2, FIG. 7, FIG. 9 and FIG. 10. Similarly to the driving circuit according to the first embodiment, in the gate control part 22, the amount In (“n” is a subscript) of the output current (Igs) from the variable current source 61, which is the amount of current of the gate drive signal GS, corresponds to the output value DADn of the parallel output Qout of the up-down counter 59. Further, at the start of an operation (an initial state), the output value of the parallel output Qout of the up-down counter 59 is DAD4 and, along therewith, the output of the variable current source 61 is Igs=I4. Referring to FIG. 10, at this time, the relationship between the drain-source voltage (Vds) and the drain-source current (Ids) is indicated by the position of a point S. Further, in the driving circuit according to the third embodiment, similarly, the minimum and maximum values of the output current from the variable current source 61 are I2 and I5, respectively.

Further, at the start of the operation (the initial state), the electric-power limit detection signal SPW outputted from the electric-power detection part 6 to the holding part 27 and the drive stop signal SB are both low (L), namely there is a state where the holding part 27 is cleared. As can be clearly seen from the description regarding FIG. 2 and the like, the external drive stop signal EXSB operates with the same polarity as that of the drive stop signal SB and, therefore, it is assumed that EXSB is L similarly to the drive stop signal SB at the start of the operation (the initial state), for convenience of description.

While the determination command signal MN is high (H), the voltage detection part 4 determines the drain-source voltage (Vds) and outputs the voltage detection signal SV. Similarly, the current detection part S determines the drain-source current (Ids) and outputs the current detection signal SI. Further, at the same timing thereas, the voltage detection signal SV and the current detection signal SI are inputted to the electric-power detection part 6, and the electric-power detection part 6 outputs the electric-power detection signal SP indicating the product of them.

If the electric-power detection signal SP is equal to or lower than a lower changeover reference voltage (a second changeover reference voltage set value) Vb, the output value from the parallel output Qout of the up-down counter 59 decreases from DADn to DADn−1, which changes the gate driving current (Igs) from In to In−1. For example, the operation point shifts from a point A on the characteristic curve for Igs=I4 to a point B on the characteristic curve for Igs=I3 in FIG. 10. If the electric-power detection signal SP is further lowered, similarly, the operation point shifts from a point C to a point D, for example, in the characteristic curves illustrated in FIG. 10.

Also, if the electric-power detection signal SP is equal to or larger than an upper changeover reference voltage (a first changeover reference voltage set value) Va, the output value from the parallel output Qout of the up-down counter 59 increases from DADn to DADn+1, which changes the gate driving current (Igs) from In to In+1. For example, the operation point shifts from a point E on the characteristic curve for Igs=I2 to a point F on the characteristic curve for Igs=I3 in FIG. 10. If the electric-power detection signal SP is further increased, similarly, the operation point shifts from a point G to a point H and from a point I to a point J, for example, in the characteristic curves illustrated in FIG. 10.

Further, if the electric-power detection signal SP gets to be equal to or larger than the upper-limit voltage Vy, the electric-power limit detection signal SPW gets to be high (H), and the holding part 27 makes the driving stop signal SB high (H), which changes the gate drive signal GS and the electric potential at the gate of the switching device 1 to a ground electric potential, thereby bringing the switching device 1 to a state where it: performs no switching operations.

Further, in the driving circuit according to the third embodiment, the way of transmission of the electric-power detection signal SP can be arbitrary, provided that it is possible to maintain the relationship between the electric-power detection signal SP and the reference voltages Va and Vb and the like.

Further, in the driving circuit according to the third embodiment, the reference voltages Va and Vb can be made variable according to the value of the up-down counter. With this structure, regarding the characteristic of controlling the loss of the switching device 1 within a certain range, it is possible to narrow or widen this range depending on situations, which enables control according to actual conditions.

Further, in the driving circuit according to the third embodiment, the electric-power detection part 6 can be adapted to output an electric-power detection signal SP having time-averaged values and, also, the holding part 27 can be adapted to make the drive stop signal SB high (H) if the electric-power limit detection signal SPW has been high (H) for a certain time period or longer, in order to enable the driving circuit to virtually neglect increases of the loss within permissible short time periods.

Further, while, in the third embodiment, the driving circuit has been described with respect to an FET which employs a p-type region as its gate, as a semiconductor device, the driving circuit according to the third embodiment can be also applied to an FET which employs a Schottky electrode as its gate to offer the same excellent effects.

The driving circuit according to the third embodiment is adapted to control the gate current with a variable current source according to the electric-power consumption between the input and output terminals in the switching device, it is also possible to control the gate voltage using a variable voltage source to offer the same effects.

Further, the driving circuit according to the third embodiment is merely an example for realizing the present invention, and the present invention is intended to cover other means and methods than those described in the third embodiment, provided that these means and methods have the same technical characteristics and offer the same functions and effects.

The driving circuit having the aforementioned structure according to the third embodiment is structured to detect an increase of the electric power consumption in a switching device from the electric power consumption between input and output terminals in the switching device and to accumulatively increase or decrease the gate current according to the increase or decrease of the electric power consumption, in cases of driving the switching device, such as an FET employing a p-type region or a Schottky electrode as its gate. As a result thereof, with the structure of the driving circuit according to the third embodiment, it is possible to control the electric power consumption in the switching device within a certain range, which enables reduction of the electric power consumption in high-load states, reduction of the loss in the gate driving circuit in low-load states and protection of the switching device against the electric power consumption therein. Accordingly, it is possible to provide a driving circuit having excellent safety and reliability and being capable of energy saving and, also, to provide a semiconductor apparatus using this driving circuit, with largely reduced fabrication costs.

### Fourth Embodiment

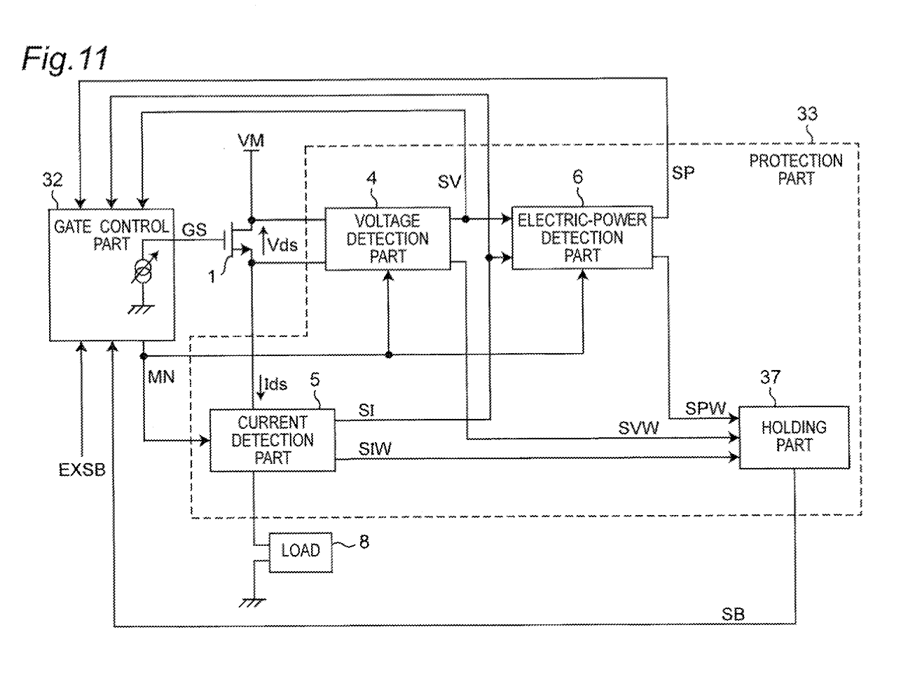

FIG. 11 is a block diagram illustrating the circuit structures of a driving circuit and a semiconductor apparatus including the driving circuit, according to a fourth embodiment of the present invention. Further, the fourth embodiment will be also described with respect to an FET which employs a p-type region as its gate, as a switching device 1 as a semiconductor device which is driven and controlled by the driving circuit. However, it goes without saying that the fourth embodiment can be also applied to an FET employing a Schottky electrode as its gate and other semiconductor devices to offer the same effects. In the following description of the fourth embodiment, components having the same functions and structures as those of the driving circuits and the semiconductor apparatuses according to the first, second and third embodiments will be designated by the same reference characters and will not be described.

As illustrated in FIG. 11, the driving circuit according to the fourth embodiment is structured such that a voltage detection signal SV from a voltage detection part 4, a current detection signal SI from a current detection part 5 and an electric-power detection signal SP from an electric-power detection part 6 are inputted to a gate control part 32. Further, the driving circuit according to the fourth embodiment is structured, such that a voltage limit detection signal SVW, a current limit detection signal SIW and an electric-power limit detection signal SPW are inputted to a holding part 37 in a protection part 33.

If any of the voltage limit detection signal SVW, the current limit detection signal SIW and the electric-power limit detection signal SPW gets to be high (H), the holding part 37 sends a drive stop signal SB being high (H) to the gate control part 32, with a method for storing the result of the logical sum of the three inputs (SVW, SIW, SPW) in a storage means, such as a flip-flop and so on. Further, even if any of the voltage limit detection signal SVW, the current limit detection signal SIW and the electric-power limit detection signal SPW drops to a low (L), again, the holding part 37 causes the drive stop signal SB to be maintained at the high (H). If at least one of the drive stop signal SB and an external drive stop signal EXSB gets to be high (H), the gate control part 32 drops the signal level of the gate drive signal GS to a ground level for stopping the driving of the switching device 1.

In the aforementioned operations, the high (H) and the low (L) of signals are merely illustrative, and it is also possible to interchange the high (H) and the low (L) of signals for performing the same operations.

Further, in the fourth embodiment, the driving circuit is constituted by the gate control part 32 and the protection part 33 which includes the voltage detection part 4, the current detection part 5, the electric-power detection part 6, and the holding part 37. Further, the semiconductor apparatus according to the fourth embodiment of the present invention is structured to include the aforementioned driving circuit, and the switching device 1 as a semiconductor device which is driven and controlled by the driving circuit. Further, in the fourth embodiment of the present invention, an operation-state detection part is constituted by the voltage detection part 4, the current detection part 5 and the electric-power detection part 6 which detect an operation state of the semiconductor device 1.

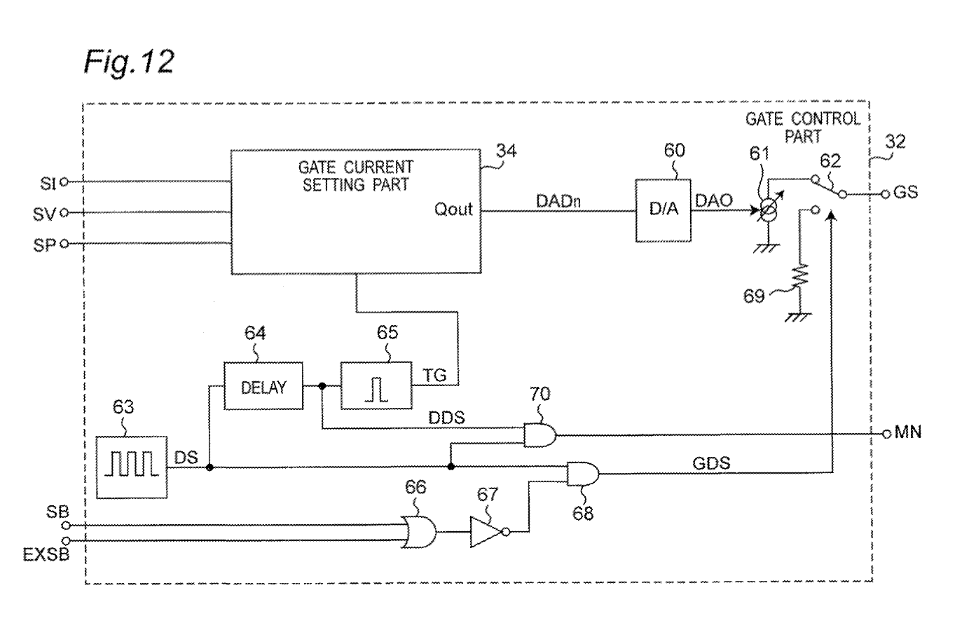

FIG. 12 is a block diagram illustrating the circuit structure of the gate control part 32 in the driving circuit according to the fourth embodiment of the present invention. In the gate control part 32 illustrated in FIG. 12, the other parts than a gate current setting part 34 have the same structures as those in the gate control part 2 in the driving circuit according to the first embodiment illustrated in FIG. 2 and also perform the same operations thereas.

As illustrated in FIG. 12, the voltage detection signal SV, the current detection signal SI and the electric-power detection signal SP are inputted to the gate current setting part 34, which outputs an output value DADn of a parallel output Qout for logical signals. The parallel output value DADn is inputted to a D/A converter 60 which converts it into a predetermined analog signal DAO. The analog signal DAO resulted from the conversion is inputted to a variable current source 61 which is controlled by analog signals, and the variable current source 61 outputs the gate drive signal GS for current driving.

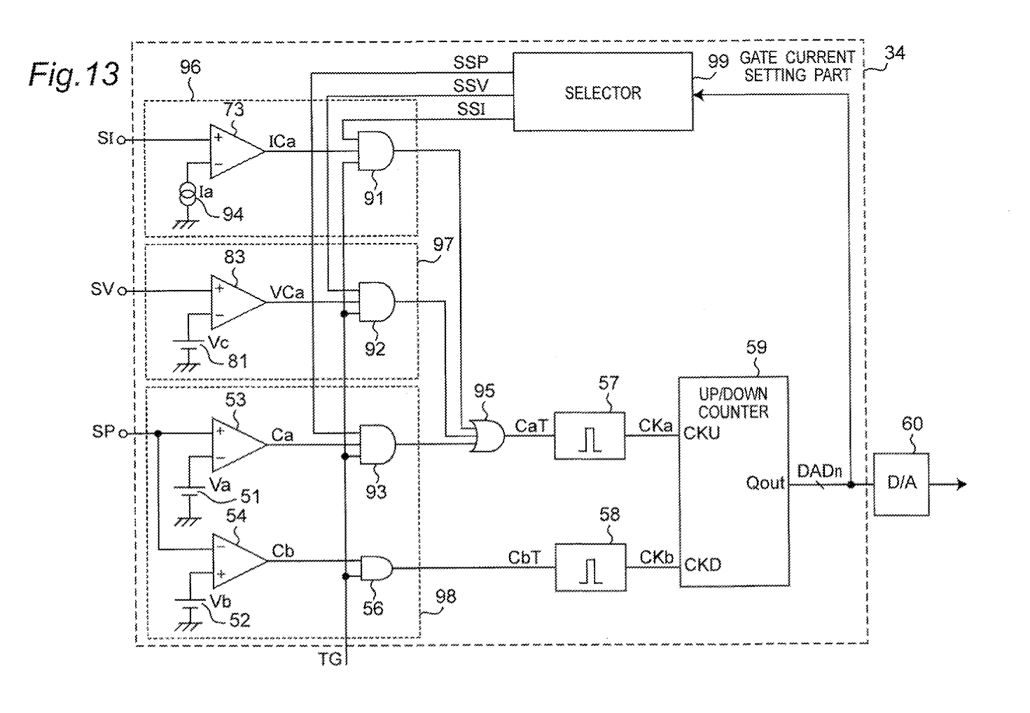

FIG. 13 is a block diagram illustrating the circuit structure of the gate current setting part 34 in the gate control part 32 in the driving circuit according to the fourth embodiment. The gate current setting part 34 according to the fourth embodiment has a structure which integrates the gate control part 2 according to the first embodiment, the gate control part 12 according to the second embodiment and the gate control part 22 according to the third embodiment, over their portions from the inputs to the up-down counters 59. The gate current setting part 34 according to the fourth embodiment includes a current detection signal determination part 96, a voltage detection signal determination part 97 and an electric-power detection signal determination part 98 and, further, includes a selector 99 which validates a single signal of output signals from the current detection signal determination part 96, the voltage detection signal determination part 97 and the electric-power detection signal determination part 98 and sends the signal to a single-pulse generator 57. In the gate current setting part 34, the single-pulse generators 57 and 58 and the up-down counter 59, which are other components than the current detection signal determination part 96, the voltage detection signal determination part 97, the electric-power detection signal determination part 98 and the selector 99, are adapted to perform the same operations as operations according to the first, second and third embodiments.

In the gate current setting part 34, the current detection signal SI is inputted to the current detection signal determination part 96, wherein the current detection signal SI is inputted to a positive terminal of a current-comparison-type comparator 37. A discharge-type reference current source 94 which outputs a reference current Ia is connected to a negative terminal of the current-comparison type comparator 73. The current-comparison type comparator 73 outputs a high (H) if the current detection signal SI as a current signal is larger than the reference current Ia and, on the contrary, outputs a low (L) if it is smaller therethan. The current-comparison type comparator 73 inputs an output ICa therefrom to a three-input AND device 91, together with a current detection selection signal SSI from the selector 99 and a signal TG outputted from the single-pulse generator 65 in the gate control part 32.

In the gate current setting part 34, the voltage detection signal SV is inputted to the voltage detection signal determination part 97, wherein the voltage detection signal SV is inputted to a positive terminal of a comparator 83. A reference voltage source 81 which outputs a reference voltage Vc is connected to a negative terminal of the comparator 83. The comparator 83 outputs a high (H) if the voltage detection signal SV is larger than the reference voltage Vc and, on the contrary, outputs a low (L) if it is smaller therethan. The comparator 83 inputs an output VCa therefrom to a three-input AND device 92, together with a voltage detection selection signal SSV from the selector 99 and a signal. TG outputted from the single-pulse generator 65 in the gate control part 32.

Further, in the gate current setting part 34, the electric-power detection signal SP as a voltage signal is inputted to the electric-power detection signal determination part 98, wherein the electric-power detection signal SP is inputted to a positive terminal of a comparator 53. A reference voltage source 51 which outputs a reference voltage Va is connected to a negative terminal of the comparator 53. The comparator 53 outputs a high (H) if the electric-power detection signal SP is larger than the reference voltage Va and, on the contrary, outputs a low (L) if it is smaller therethan. The comparator 53 inputs an output Ca therefrom to a three-input AND device 93, together with an electric-power detection selection signal SSP from the selector 99 and a signal TG outputted from the single-pulse generator 65 in the gate control part 32.

Further, the electric-power detection signal SP is inputted to a negative terminal of a comparator 54. A reference voltage source 52 which outputs a reference voltage Vb is connected to a positive terminal of the comparator 54. The comparator 54 outputs a high (H) if the electric-power detection signal SP is smaller than the reference voltage Vb and, on the contrary, outputs a low (L) if it is larger therethan. The comparator 54 inputs an output Cb therefrom to an AND device 56, together with a signal TG outputted from the single-pulse generator 65 in the gate control part 32.

The outputs Ca and Cb form the comparators 53 and 54 perform substantially the same operations as those of the gate control part 2 according to the first embodiment illustrated in FIG. 2 and the gate control part 22 according to the third embodiment.

The selector 99 in the gate current setting part 34 has the function of outputting only a single signal out of the current detection selection signal SSI, the electric-power detection selection signal SSV and the electric-power detection selection signal SSP such that this single signal is high (H), while outputting the remaining two signals such that they are low (L), if the output value DADn of the parallel output Qout from the up-down counter 59 is inputted to the selector 99. Further, the three-input AND devices 91, 92 and 93 in the gate current setting part 34 input: their outputs to a three-input OR device 95, which inputs an output signal CaT therefrom to the single-pulse generator 57.

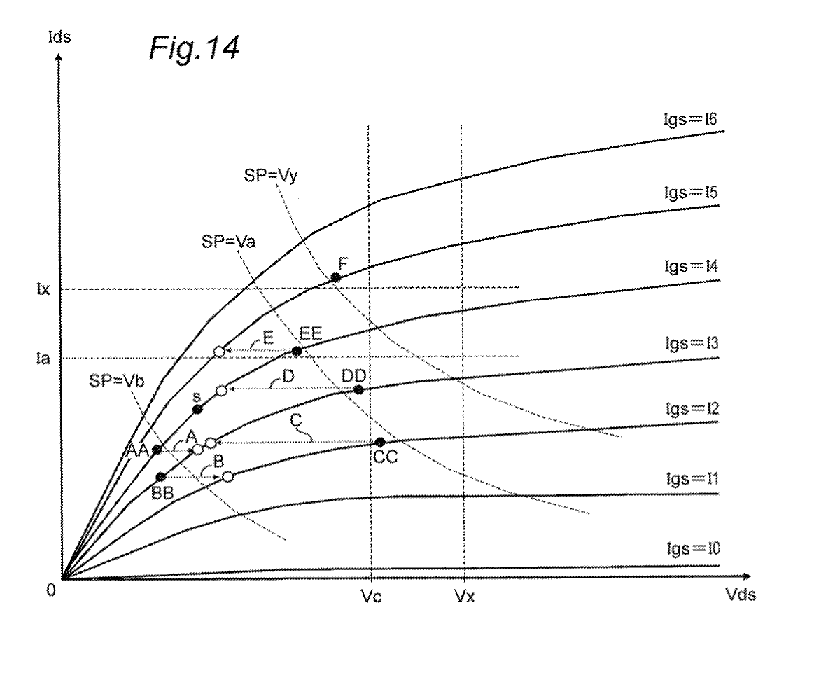

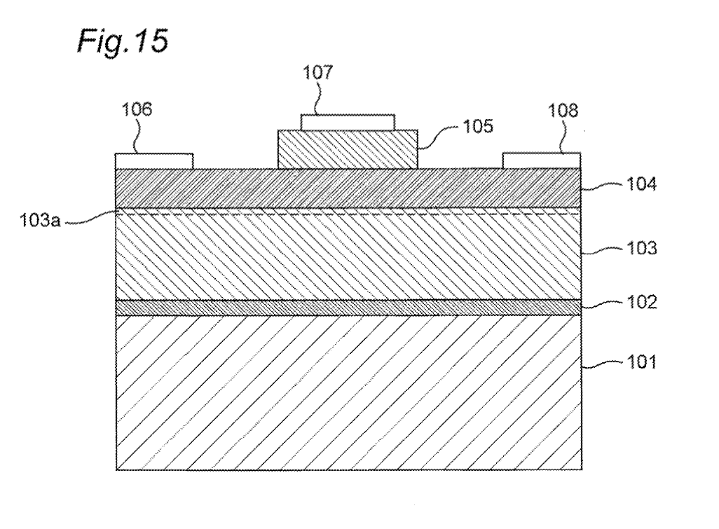

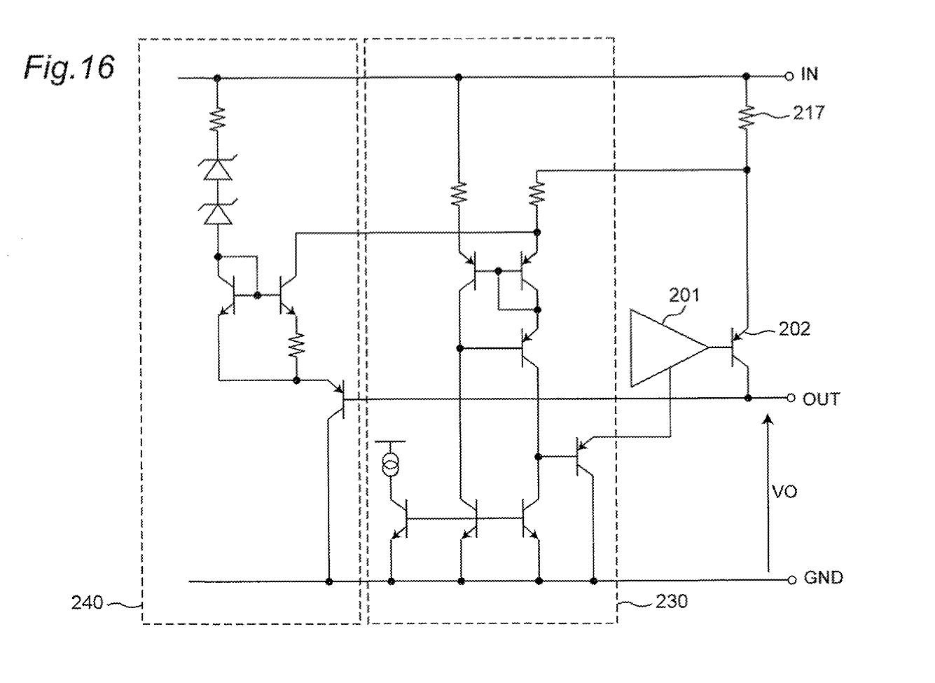

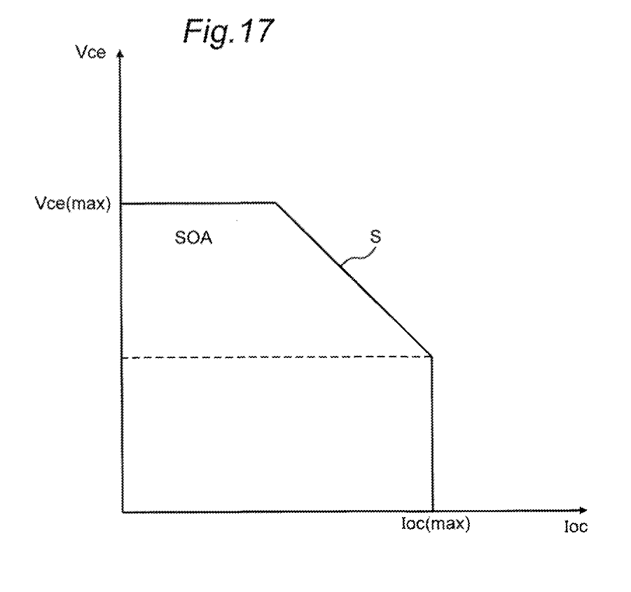

FIG. 14 is a characteristic diagram illustrating the relationship between the drain-source voltage (Vds) and the drain-source current (Ids) in the FET switching device which employs a p-type region as its gate. In FIG. 14, there are illustrated states of transitions of the operation point of the switching device 1 according to the fourth embodiment. However, similarly to in FIG. 4, there is illustrated the relationship between the gate-source voltage (Vgs) and the gate-source current (Igs) for each value of the gate-source current (Igs). Further, in FIG. 14, the respective curves represented as SP=Va, Vb and Vy are curves indicating relationships which make the loss of the switching device constant at the voltages Va, Vb and Vy, wherein the loss of the switching device is the product of the drain-source voltage (Vds) and the drain-source current (Ids).

[Operations of the Driving Circuit]

Hereinafter, there will be described operations of the driving circuit according to the fourth embodiment, with reference to FIGS. 11 to 14. In operations of the driving circuit according to the fourth embodiment, basic operations are the same as the operations described in the first to third embodiments, unless otherwise specified. Similarly to in the first and second embodiments, the output value DADn of the parallel output Qout from the up-down counter 59 in the gate control part 32 and the output current (Igs) from the variable current source 61, which is the amount of current of the gate drive signal GS, has the relationship corresponding to that of DADn and In, as illustrated in FIG. 7. Further, at the start of an operation (an initial state), the output value of the parallel output Qout from the up-down counter 59 is DAD4 and, along therewith, the output of the variable current source 61 is Igs=I4. At this time, the relationship between the drain-source voltage (Vds) and the drain-source current (Ids) is indicated by the position of a point S in FIG. 14. Further, in the driving circuit according to the fourth embodiment, similarly, the minimum and maximum values of the output current from the variable current source 61 are I2 and I5, respectively.

Further, at the start of the operation (the initial state), a voltage limit detection signal SVW, a current limit detection signal SIW and an electric-power limit detection signal SPW outputted from the voltage detection part 4, the current detection part 5 and the electric-power detection part 6 to the holding part 17, and the drive stop signal SB are low (L), namely there is a state where the holding part 17 is cleared. As can be clearly seen in FIG. 12, the external drive stop signal EXSB operates with the same polarity as that of the drive stop signal SB and, therefore, it is assumed that EXSB is L similarly to the drive stop signal SB at the start of the operation (the initial state), for convenience of description.

Further, in the fourth embodiment, it is assumed that the drain-source current (Ids) equals to the current value of the current detection signal SI when the determination command signal MN is H, for convenience of description.

While the determination command signal MN is high (H), the voltage detection part 4 determines the drain-source voltage (Vds) and outputs the voltage detection signal SV. Similarly, the current detection part 5 determines the drain-source current (Ids) and outputs the current detection signal SI. Further, at the same timing thereas, the voltage detection signal SV and the current detection signal SI are inputted to the electric-power detection part 6, and the electric-power detection part 6 outputs the electric-power detection signal SP indicating the product of them.

For example, referring to the characteristic curves illustrated in FIG. 14, a point CC indicates an operation point indicating that the output value of the parallel output Qout from the up-down counter 59 is DAD2, and the output from the variable current source 61 is Igs=I2. Within the area including the operation point at the point CC, the voltage detection part 4 determines that the drain-source voltage (Vds) is equal to or larger than the reference voltage Vc. Accordingly, the selector 99 makes the voltage detection selection signal SSV high (H) with respect to the input value DAD2, and the comparator 83 inputs its output VCa being high (H) to the three-input AND device 92, which provides an input to the single-pulse generator 57 through the three-input OR device 95 (see FIG. 13).

Further, for example, referring to the characteristic curves illustrated in FIG. 14, a point DD indicates an operation point indicating that the output value of the parallel output Qout from the up-down counter 59 is DAD3, and the output from the variable current source 61 is Igs=I3. Within the area including the operation point at the point DD, the electric-power detection part 6 determines that the electric-power detection signal SP is equal to or larger than Va. Accordingly, the selector 99 makes the electric-power detection selection signal SSP high (H) with respect to the input value DAD3, and the comparator 53 inputs its output Ca being high (H) to the three-input AND device 93, which provides an input to the single-pulse generator 57 through the three-input OR device 95 (see FIG. 13).

Further, for example, referring to the characteristic curves illustrated in FIG. 14, a point EE indicates an operation point indicating that the output value of the parallel output Qout from the up-down counter 59 is DAD4, and the output from the variable current source 61 is Igs=I4. Within the area including the operation point at the point EE, the current detection part 5 determines that the current detection signal SI is equal to or larger than Ia. Accordingly, the selector 99 makes the current detection selection signal SSI high (H) with respect to the input value DAD4, and the current-comparison type comparator 73 inputs its output ICa being high (H) to the three-input AND device 91, which provides an input to the single-pulse generator 57 through the three-input OR device 95 (see FIG. 13).

Through the aforementioned operations, the output value of the parallel output Qout from the up-down counter 59 increases from DADn to DADn+1, which changes the gate driving current from In to In+1, thereby causing a transition of the operation point from the point CC in the direction of an arrow C, a transition of the operation point from the point DD in the direction of an arrow D, and a transition of the operation point from the point EE in the direction of an arrow E, in the characteristic curves illustrated in FIG. 14, for example.

Further, for example, referring to the characteristic curves illustrated in FIG. 14, a point AA indicates an operation point indicating that the output value of the parallel output Qout from the up-down counter 59 is DAD4, and the output from the variable current source 61 is Igs=I4. Within the area including the operation point at the point AA, the electric-power detection part 6 determines that the electric-power detection signal SP is equal to or smaller than Vb. Accordingly, the selector 99 makes the electric-power detection selection signal SSP high (H) with respect to the input value DAD4, and the comparator 54 inputs its output Cb being high (H) to the three-input AND device 56, which outputs an output signal CbT to the single-pulse generator 58.

Consequently, the single-pulse generator 58 generates a signal CKb having a single pulse and inputs it to the count-down input CKD in the up-down counter 59. As a result thereof, the output value of the parallel output Qout from the up-down counter 59 decreases from DAD4 to DAD3. Along therewith, the output current from the variable current source 61, namely the gate driving current Igs, decreases from I4 to I3.

Through the aforementioned operations, the output value of the parallel output Qout from the up-down counter 59 decreases from DADn to DADn−1, which changes the gate driving current from In to In−1, thereby causing a transition of the operation point from the point AA in the direction of an arrow A and a transition of the operation point from the point BB in the direction of an arrow B, in the characteristic curves illustrated in FIG. 14, for example.

If the electric-power detection signal SP gets to be equal to or larger than the upper-limit voltage Vy, the electric-power limit detection signal SPW gets to be high (H), which causes the holding part 37 to make the drive stop signal SB high (H). Similarly, if the voltage detection signal SV gets to be equal to or larger than the upper-limit voltage Vx, the voltage limit detection signal SVW gets to be high (H), which causes the holding part 37 to make the drive stop signal SB high (H). Further, if the current detection signal SI gets to be equal to or larger than the upper-limit current Ix, the current limit detection signal SIW gets to be high (H), which causes the holding part 37 to make the drive stop signal SB high (H). As described above, when the holding part 37 makes the driving stop signal SB high (H), the gate drive signal GS and the electric potential at the gate of the switching device 1 are shifted to a ground electric potential, thereby bringing the switching device 1 to a state where it performs no switching operations.

Further, in the driving circuit according to the fourth embodiment, the reference voltages Va, Vb and Vc and the reference current Ia can be made variable according to the output value of the up-down counter 59. With this structure, regarding the characteristic of controlling the loss of the switching device 1 within a certain range, it is possible to narrow or widen this range depending on situations, which enables control according to actual conditions.

Further, in the driving circuit according to the fourth embodiment, the respective detection parts for the voltage, the current and the electric power can be also adapted to output detection signals (SV, SI, SP) having time-averaged values and, also, the holding part 37 can be adapted to make the drive stop signal SB high (H) if the respective limit detection signals (SVW, SIW, SIW) have been high (H) for a certain time period or longer, in order to enable the driving circuit to virtually neglect loss increases within permissible short time periods.

Further, while the driving circuit according to the fourth embodiment has been described with respect to an FET which employs a p-type region as its gate, as a semiconductor device, the driving circuit according to the fourth embodiment can be also applied to an FET which employs a Schottky electrode as its gate to offer the same excellent effects.

The driving circuit according to the fourth embodiment is adapted to control the gate current with a variable current source according to the drain-source voltage, the drain-source current, and the electric-power consumption between the input and output terminals in the switching device, it is also possible to control the gate voltage using a variable voltage source to offer the same effects.

Further, the driving circuit according to the fourth embodiment is merely an example for realizing the present invention, and the present invention is intended to cover other means and methods than those described in the fourth embodiment, provided that these means and methods have the same technical characteristics and offer the same functions and effects.

The driving circuit having the aforementioned structure according to the fourth embodiment is structured to detect an increase of the electric power consumption in a switching device from the voltage, the current and the electric power consumption between input and output terminals in the switching device and to accumulatively increase or decrease the gate current according to the increase or decrease of the electric power consumption, in cases of driving the switching device, such as an FET employing a p-type region or a Schottky electrode as its gate. As a result thereof, with the structure of the driving circuit according to the fourth embodiment, it is possible to perform control for causing the operation range of the switching device to fall within the range of a so-called safe operation area, which enables reduction of the electric power consumption in high-load states, reduction of the loss in the gate driving circuit in low-load states and protection of the switching device in view of the voltage, the current and the electric power consumption therein. Accordingly, it is possible to provide a driving circuit and a semiconductor apparatus using this driving circuit, with fabrication costs largely reduced in comparison with conventional structures.

As previously described in detail in the first to fourth embodiments, according to the present invention, with the driving circuit for driving and controlling a semiconductor device which employs a p-type region or a Schottky electrode as its gate and with the semiconductor apparatus which employs the driving circuit, it is possible to detect an operation state of the semiconductor device, such as an electric-power consumption state, from electric power consumption, based on the voltage between input and output terminals in the semiconductor device, the output current from the semiconductor device or both the voltage between the input and output terminals of the semiconductor device and the output current thereof, and to accumulatively increase or decrease the gate current according to the increase or decrease of the electric power consumption. Accordingly, it is possible to integrate the function of protecting this semiconductor device against excessive voltages, excessive currents and excessive electric power consumption and the function of reducing the loss of the semiconductor device, as well as reducing the electric power consumption of the semiconductor device in high-load states and reducing the loss in the driving circuit in low-load states. Accordingly, it is possible to provide a driving circuit and a semiconductor apparatus which have excellent safety and reliability and can attain energy saving, with simple structures and reduced fabrication costs.

Further, according to the present invention, it is possible to differentiate accumulative increases or decreases of the gate current, according to the voltage between input and output terminals in the semiconductor device, the output current and the electric-power consumption, depending on the magnitude of the gate current at the time of determination. Accordingly, it is possible to provide a driving circuit and a semiconductor apparatus which are capable of operations for protecting the semiconductor device in consideration of safe operation areas.

The driving circuit and the semiconductor apparatus according to the present invention have the functions of reducing electric-power consumption in a semiconductor device, such as an FET employing a p-type region or a Schottky electrode as its gate in high-load states, reducing the loss in the driving circuit in low-load states, and protecting the semiconductor device. Accordingly, the present invention is an invention with general versatility which can be applied to various types of electronic and electric apparatuses.

What is claimed is:

1. A semiconductor-device driving circuit comprising:
an operation-state detection part adapted to detect an operation state of a semiconductor device which exhibits a diode characteristic of flowing an abrupt current when a gate-source voltage exceeds a predetermined voltage; and
a gate control part adapted to receive a signal indicative of the operation state of the semiconductor device from the operation-state detection part and to control a voltage or current supplied to the gate of the semiconductor device according to the signal indicative of the operation state of the semiconductor device.

2. The semiconductor-device driving circuit according to claim 1, wherein
the semiconductor device has a p-type region or a Schottky electrode as its gate,
the operation-state detection part includes a voltage detection part adapted to determine the voltage between input and output terminals in the semiconductor device, and
on receiving a determined voltage value of the voltage between the input and output terminals in the semiconductor device from the voltage detection part, the gate control part controls the current supplied to the gate of the semiconductor device, when the determined voltage value exceeds at least a changeover reference voltage set value.

3. The semiconductor-device driving circuit according to claim 2, wherein
the gate control part is adapted to receive a determined voltage value of the voltage between the input and output terminals in the semiconductor device, from the voltage detection part, at every predetermined periodic interval,
when the determined voltage value is equal to or larger than a first changeover reference voltage set value, the gate control part makes the gate current supplied to the gate of the semiconductor device equal to the gate current before the determination plus a predetermined amount, such that a first gate current set value is an upper limit, and
when the determined voltage value is equal to or smaller than a second changeover reference voltage set value, the gate control part makes the gate current supplied to the gate of the semiconductor device equal to the gate current before the determination minus a predetermined amount, such that a second gate current set value is a lower limit.

4. The semiconductor-device driving circuit according to claim 2, wherein
the gate control part is adapted to receive a determined voltage value of the voltage between the input and output terminals in the semiconductor device from the voltage detection part and adapted to stop the driving of the semiconductor device, after the determined voltage value gets to be equal to or larger than an upper-limit reference voltage set value.

5. The semiconductor-device driving circuit according to claim 3, wherein
the gate control part is adapted to receive a determined voltage value of the voltage between the input and output terminals in the semiconductor device from the voltage detection part and adapted to stop the driving of the semiconductor device, after the determined voltage value gets to be equal to or larger than an upper-limit reference voltage set value.

6. The semiconductor-device driving circuit according to claim 1, wherein
the semiconductor device has a p-type region or a Schottky electrode as a gate,
the operation-state detection part includes a current detection part adapted to determine the output current of the semiconductor device, and
on receiving a determined current value of the output current of the semiconductor device, the gate control part controls the current supplied to the gate of the semiconductor device, when the determined current value of the output current of the semiconductor device exceeds at least a changeover reference current set value.

7. The semiconductor-device driving circuit according to claim 6, wherein
the gate control part is adapted to receive a determined current value of the output current of the semiconductor device, from the current detection part, at every predetermined periodic interval,
when the determined current value is equal to or larger than a first changeover reference current set value, the gate control part makes the gate current supplied to the gate of the semiconductor device equal to the gate current before the determination plus a predetermined amount, such that a first gate current set value is an upper limit, and
when the determined current value is equal to or smaller than a second changeover reference current set value, the gate control part makes the gate current supplied to the gate of the semiconductor device equal to the gate current before the determination minus a predetermined amount, such that a second gate current set value is a lower limit.

8. The semiconductor-device driving circuit according to claim 6 wherein
the gate control part is adapted to receive a determined current value of the output current of the semiconductor device from the current detection part and adapted to stop the driving of the semiconductor device, after the determined current value gets to be equal to or larger than an upper-limit reference current set value.

9. The semiconductor-device driving circuit according to claim 7 wherein
the gate control part is adapted to receive a determined current value of the output current of the semiconductor device from the current detection part and adapted to stop the driving of the semiconductor device, after the determined current value gets to be equal to or larger than an upper-limit reference current set value.

10. The semiconductor-device driving circuit according to claim 1, wherein
the semiconductor device has a p-type region or a Schottky electrode as a gate,
the operation-state detection part includes
a voltage detection part adapted to determine the voltage between input and output terminals in the semiconductor device,
a current detection part adapted to determine the output current of the semiconductor device, and
an electric-power detection part adapted to determine electric power consumption in the semiconductor device, from a determined voltage value of the voltage between the input and output terminals from the voltage detection part, and from a determined current value of the output current from the current detection part, and
the gate control part, on receiving a determined value of the electric power consumption in the semiconductor device, controls the current supplied to the gate of the semiconductor device, when the determined value of the electric power consumption in the semiconductor device exceeds at least a changeover reference electric-power set value.

11. The semiconductor-device driving circuit according to claim 10, wherein
the gate control part is adapted to receive a determined value of the electric power consumption in the semiconductor device from the electric-power detection part, at every predetermined periodic interval,
when the determined value of the electric-power consumption is equal to or larger than a first changeover reference electric-power set value, the gate control part makes the gate current supplied to the gate of the semiconductor device equal to the gate current before the determination plus a predetermined amount, such that a first gate current set value is an upper limit, and
when the determined value of the electric power consumption is equal to or smaller than a second changeover reference electric-power set value, the gate control part makes the gate current supplied to the gate of the semiconductor device equal to the gate current before the determination minus a predetermined amount, such that a second gate current set value is a lower limit.

12. The semiconductor-device driving circuit according to claim 10, wherein
the gate control part is adapted to receive a determined value of the electric power consumption in the semiconductor device from the electric-power detection part and adapted to stop the driving of the semiconductor device, after the determined value of the electric power consumption gets to be equal to or larger than an upper-limit reference electric-power set value.

13. The semiconductor-device driving circuit according to claim 11, wherein
the gate control part is adapted to receive a determined value of the electric power consumption in the semiconductor device from the electric-power detection part and adapted to stop the driving of the semiconductor device, after the determined value of the electric power consumption gets to be equal to or larger than an upper-limit reference electric-power set value.

14. The semiconductor-device driving circuit according to claim 1, wherein
the semiconductor device has a p-type region or a Schottky electrode as a gate,
the operation-state detection part includes
a voltage detection part adapted to determine the voltage between input and output terminals in the semiconductor device,
a current detection part adapted to determine the output current of the semiconductor device, and
an electric-power detection part adapted to determine electric power consumption in the semiconductor device, from a determined voltage value of the voltage between the input and output terminals from the voltage detection part, and from a determined current value of the output current from the current detection part, and
the gate control part is adapted to control the current supplied to the gate of the semiconductor device, when a determined voltage value from the voltage detection part exceeds at least a changeover reference voltage set value, when a determined current value from the current detection part exceeds at least a changeover reference current set value, or when a determined value of the electric power consumption from the electric-power detection part exceeds at least a changeover reference electric-power set value.

15. The semiconductor-device driving circuit according to claim 14, wherein
the gate control part is adapted to receive a determined voltage value of the voltage between the input and output terminals in the semiconductor device from the voltage detection part, a determined current value of the output current of the semiconductor device from the current detection part, and a determined value of the electric power consumption in the semiconductor device from the electric-power detection part, and
the gate control part includes a selector for selectively performing, according to the magnitude of the gate current, an operation out of a first operation for, when the determined voltage value is equal to or larger than a changeover reference voltage set value, making the gate current supplied to the gate of the semiconductor device equal to the gate current before the determination plus a predetermined amount such that a first gate current set value is an upper limit, a second operation for, when the determined current value is equal to or larger than a changeover reference current set value, making the gate current supplied to the gate of the semiconductor device equal to the gate current before the determination plus a predetermined amount such that a second gate current set value is an upper limit, and a third operation for, when the determined electric-power-consumption value is equal to or larger than a first changeover reference electric-power set value, making the gate current supplied to the gate of the semiconductor device equal to the gate current before the determination plus a predetermined amount such that a third gate current set value is an upper limit, and
when the determined electric-power-consumption value is equal to or smaller than a second changeover reference electric-power set value, regardless of the operation selected by the selector, the gate control part makes the gate current supplied to the gate of the semiconductor device equal to the gate current before the determination minus a predetermined amount, such that a fourth gate current set value is a lower limit.

16. The semiconductor-device driving circuit according to claim 14, wherein
the gate control part is adapted to stop the driving of the semiconductor device, after the determined voltage value gets to be equal to or larger than an upper-limit reference voltage set value, after the determined current value gets to be equal to or larger than an upper-limit reference current set value, and after the determined electric-power-consumption value gets to be equal to or larger than an upper-limit reference electric-power set value.

17. The semiconductor-device driving circuit according to claim 15, wherein
the gate control part is adapted to stop the driving of the semiconductor device, after the determined voltage value gets to be equal to or larger than an upper-limit reference voltage set value, after the determined current value gets to be equal to or larger than an upper-limit reference current set value, and after the determined electric-power-consumption value gets to be equal to or larger than an upper-limit reference electric-power set value.

18. The semiconductor-device driving circuit according to claim 1, wherein
the semiconductor device is an FET which employs a p-type region or a Schottky electrode as a gate.

19. A semiconductor apparatus comprising the semiconductor-device driving circuit according to claim 1, and a semiconductor device adapted to be driven and controlled by the driving circuit.
